(19) United States
(12) Patent Application Publication
(10) Pub. No.: US 2025/0031085 A1
(43) Pub. Date: Jan. 23, 2025

(54) CHANNEL STATE INFORMATION REPORTING

(71) Applicant: Samsung Electronics Co., Ltd., Suwon-si (KR)

(72) Inventors: Md. Saifur Rahman, Plano, TX (US); Eko Onggosanusi, Coppell, TX (US); Gilwon Lee, McKinney, TX (US)

(21) Appl. No.: 18/764,089

(22) Filed: Jul. 3, 2024

Related U.S. Application Data
(60) Provisional application No. 63/526,899, filed on Jul. 14, 2023.

(51) Int. Cl. H04W 24/10; H04L 5/00

(52) U.S. Cl. CPC H04W 24/10; H04L 5/0051

(57) ABSTRACT

Apparatuses and methods for CSI reporting. A method performed by a user equipment (UE) includes receiving a configuration about a channel state information (CSI) report. The configuration includes information about (i) K>1 non-zero power (NZP) CSI-reference signal (RS) resources and (ii) a codebookType. The codebookType indicates a codebook associated with P_{CSIRS} CSI-RS ports aggregated across the K NZP CSI-RS resources. The method further includes, based on the configuration, determining, a number of layers (v) and when v>1, determining a vector bᵣ for each pair of consecutive layers (2r−1,2r) and determining one of: (A) a coefficient cᵣ for each pair of consecutive layers (2r−1,2r) and (B) a coefficient c for each layer l=1, . . . , v. The method further includes transmitting the CSI report including at least one vector indicator indicating vectors {bᵣ} and at least one coefficient indicator indicating coefficients. P_{CSIRS}>32, r=1, . . . , ┌v/2┐, and each vector has a length dependent on P_{CSIRS}.

### CROSS-REFERENCE TO RELATED APPLICATION AND CLAIM OF PRIORITY

This application claims priority under 35 U.S.C. § 119 (e) to U.S. Provisional Patent Application No. 63/526,899 filed on Jul. 14, 2023, which provisional patent application is hereby incorporated by reference in its entirety.

### TECHNICAL FIELD

The present disclosure relates generally to wireless communication systems and, more specifically, to channel state information (CSI) reporting.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for CSI reporting.

In one embodiment, a user equipment (UE) is provided. The UE includes a transceiver configured to receive a configuration about a CSI report. The configuration includes information about (i) K>1 non-zero power (NZP) CSI-reference signal (RS) resources and (ii) a codebookType. The codebookType indicates a codebook associated with P_{CSIRS} CSI-RS ports aggregated across the K NZP CSI-RS resources. The UE further includes processor operably coupled to the transceiver. The processor, based on the configuration, is configured to determine, a number of layers (v); and when v>1, determine a vector bᵣ for each pair of consecutive layers (2r−1,2r) and determine one of: (A) a coefficient cᵣ for each pair of consecutive layers (2r−1,2r) and (B) a coefficient c for each layer l=1, . . . , v. The transceiver is configured to transmit the CSI report including at least one vector indicator indicating vectors {bᵣ} and at least one coefficient indicator indicating coefficients. P_{CSIRS}>32, r=1, . . . , ┌v/2┐, and each vector has a length dependent on P_{CSIRS}.

In another embodiment, a base station (BS) is provided. The BS includes a processor and a transceiver operably coupled to the processor. The transceiver is configured to transmit a configuration about a CSI report. The configuration includes information about (i) K>1 NZP CSI-RS resources and (ii) a codebookType. The codebookType indicates a codebook associated with P_{CSIRS} CSI-RS ports aggregated across the K NZP CSI-RS resources. The transceiver is further configured to receive the CSI report including at least one vector indicator indicating vectors {bᵣ} and at least one coefficient indicator indicating coefficients. When a number of layers (v)>1, a vector bᵣ is determined for each pair of consecutive layers (2r−1,2r) and one of: (A) a coefficient cᵣ is determined for each pair of consecutive layers (2r−1,2r) and (B) a coefficient cₗ is determined for each layer l=1, . . . , v. P_{CSIRS}>32, r=1, . . . , ┌v/2┐, and each vector has a length dependent on P_{CSIRS}.

In yet another embodiment, a method performed by a UE is provided. The method includes receiving a configuration about a CSI report. The configuration includes information about (i) K>1 NZP CSI-RS resources and (ii) a codebookType. The codebookType indicates a codebook associated with P_{CSIRS} CSI-RS ports aggregated across the K NZP CSI-RS resources. The method further includes, based on the configuration, determining, a number of layers (v) and when v>1, determining a vector bᵣ for each pair of consecutive layers (2r−1,2r) and determining one of: (A) a coefficient cᵣ for each pair of consecutive layers (2r−1,2r) and (B) a coefficient c for each layer l=1, . . . , v. The method further includes transmitting the CSI report including at least one vector indicator indicating vectors {bᵣ} and at least one coefficient indicator indicating coefficients. P_{CSIRS}>32, r=1, . . . , 2%, and each vector has a length dependent on P_{CSIRS}.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4 and 5 illustrate example wireless transmit and receive paths according to embodiments of the present disclosure;

FIG. 6 illustrates a transmitter block diagram for a physical downlink shared channel (PDSCH) in a subframe according to embodiments of the present disclosure;

FIG. 7 illustrates a receiver block diagram for a PDSCH in a subframe according to embodiments of the present disclosure;

FIG. 8 illustrates a transmitter block diagram for a physical uplink shared channel (PUSCH) in a subframe according to embodiments of the present disclosure;

FIG. 9 illustrates a receiver block diagram for a PUSCH in a subframe according to embodiments of the present disclosure;

FIG. 10 illustrates an example antenna blocks or arrays forming beams according to embodiments of the present disclosure;

FIG. 11 illustrates an example antenna port layout and antenna group TRP according to embodiments of the present disclosure;

FIG. 12 illustrates co-located and distributed antenna groups (AGs) serving a moving UE according to embodiments of the present disclosure;

FIG. 13 illustrates an example of a UE configured to receive a burst of non-zero power (NZP) CSI reference signal (CSI-RS) resources according to embodiments of the present disclosure;

FIG. 14 illustrates an example of a UE configured to determine a value of N₄ based on the value B in a CSI-RS burst according to embodiments of the present disclosure;

FIG. 15 illustrates an example of a UE configured to partition the A RBs into subbands (SBs) and/or the B time instances into sub-times (STs) according to embodiments of the present disclosure;

FIG. 16 illustrates spatial-domain (SD) units (in 1^{st} and 2^{nd} antenna dimensions), frequency-domain FD units, and time-domain (TD) units according to embodiments of the present disclosure;

FIG. 17 illustrates examples of W1 and W2 according to embodiments of the present disclosure;

FIG. 18 illustrates an orthogonal basis set for DFT beams according to embodiments of the present disclosure

FIG. 19 illustrates an example of a two beam sorting scheme according to embodiments of the present disclosure; and

FIG. 20 illustrates an example method performed by a UE in a wireless communication system according to embodiments of the present disclosure.

### DETAILED DESCRIPTION

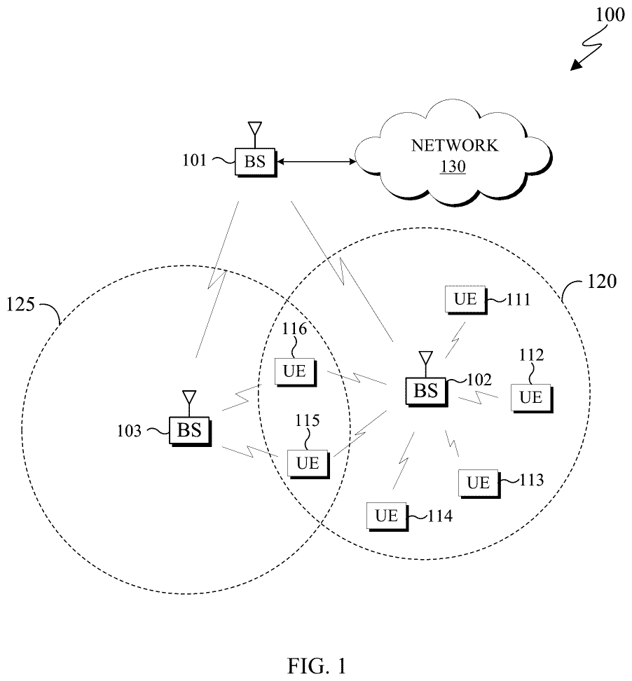

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.3.0, “E-UTRA, Physical channels and modulation (herein “REF 1”);” 3GPP TS 36.212 v17.1.0, “E-UTRA, Multiplexing and Channel coding” (herein “REF 2”); 3GPP TS 36.213 v17.3.0, “E-UTRA, Physical Layer Procedures” (herein “REF 3”); 3GPP TS 36.321 v17.3.0, “E-UTRA, Medium Access Control (MAC) protocol specification” (herein “REF 4”); 3GPP TS 36.331 v17.3.0, “E-UTRA, Radio Resource Control (RRC) Protocol Specification” (herein “REF 5”); 3GPP TR 22.891 v1.2.0 (herein “REF 6”); 3GPP TS 38.212 v17.3.0, “E-UTRA, NR, Multiplexing and Channel coding” (herein “REF 7”); 3GPP TS 38.214 v17.3.0, “E-UTRA, NR, Physical layer procedures for data” (herein “REF 8”); 3GPP TS 38.211 v17.3.0, “E-UTRA, NR, Physical channels and modulation” (herein “REF 9”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

In the 5G/NR system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for CSI reporting. In certain embodiments, one or more of the BSs 101-103 include circuitry, programing, or a combination thereof for facilitating CSI reporting.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

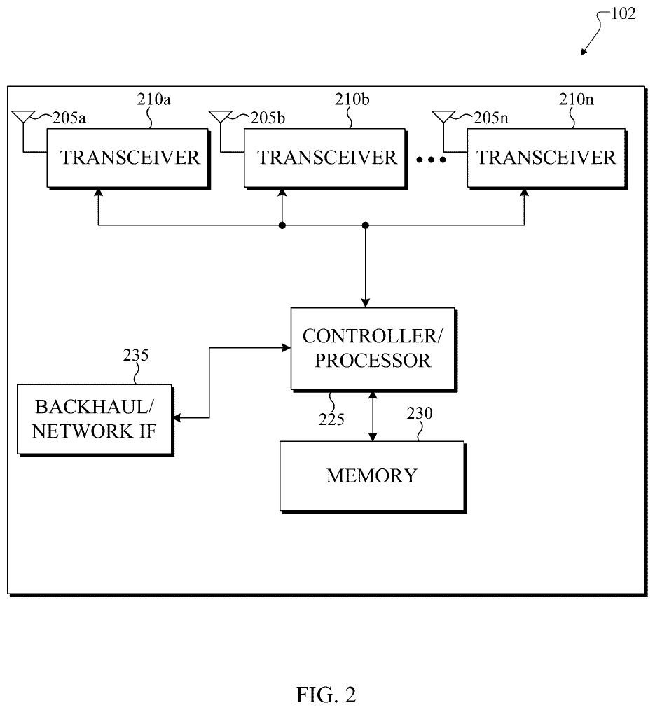

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for facilitating CSI reporting. Any of a wide variety of other functions could be supported in the gNB 102 by the controller/processor 225.

The controller/processor 225 is also capable of executing programs and other processes resident in the memory 230, such as processes for facilitating CSI reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

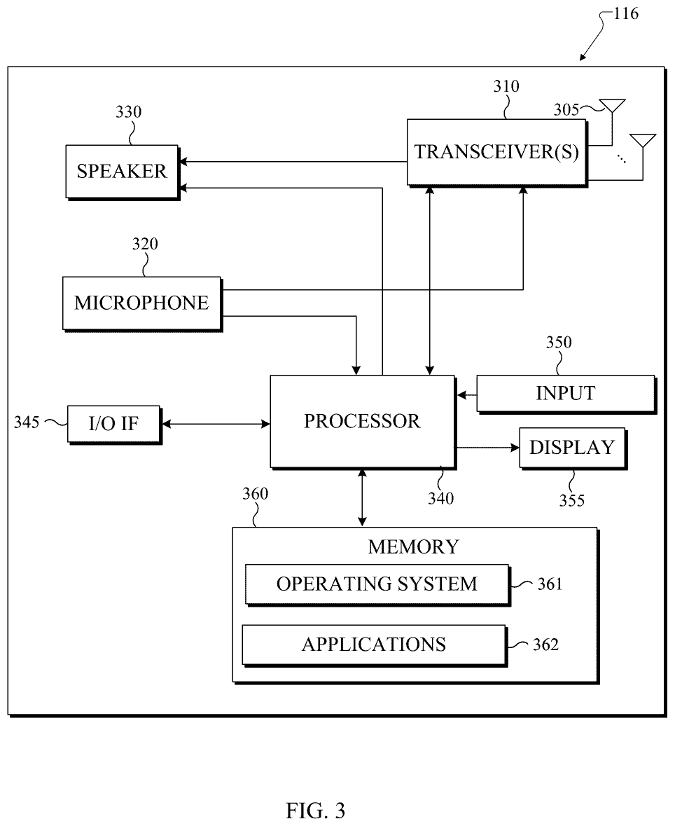

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for CSI reporting. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

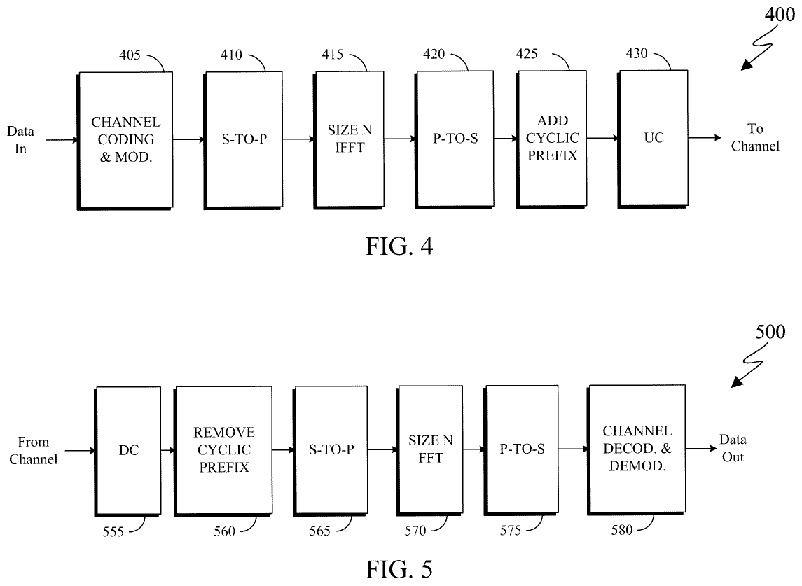

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the transmit path 400 is configured to facilitate CSI reporting as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A communication system includes a downlink (DL) that conveys signals from transmission points such as base stations (BSs) or NodeBs to user equipments (UEs) and an Uplink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE, DL signals can include data signals conveying information content, control signals conveying DL control information (DCI), and reference signals (RS) that are also known as pilot signals. An eNodeB transmits data information through a physical DL shared channel (PDSCH). An eNodeB transmits DCI through a physical DL control channel (PDCCH) or an Enhanced PDCCH (EPDCCH)—see also REF 3. An eNodeB transmits acknowledgement information in response to data transport block (TB) transmission from a UE in a physical hybrid ARQ indicator channel (PHICH). An eNodeB transmits one or more of multiple types of RS including a UE-common RS (CRS), a channel state information RS (CSI-RS), or a demodulation RS (DMRS). A CRS is transmitted over a DL system bandwidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe and can have, for example, duration of 1 millisecond.

DL signals also include transmission of a logical channel that carries system control information. A BCCH is mapped to either a transport channel referred to as a broadcast channel (BCH) when the DL signals convey a master information block (MIB) or to a DL shared channel (DL-SCH) when the DL signals convey a System Information Block (SIB). Most system information is included in different SIBs that are transmitted using DL-SCH. A presence of system information on a DL-SCH in a subframe can be indicated by a transmission of a corresponding PDCCH conveying a codeword with a cyclic redundancy check (CRC) scrambled with system information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe and a group of physical resource blocks (PRBs). A transmission BW includes frequency resource units referred to as resource blocks (RBs). Each RB includes N_{sc}^{RB} sub-carriers, or Resource Elements (REs), such as 12 REs. A unit of one RB over one subframe (or slot) is referred to as a PRB. A UE can be allocated M_{PDSCH} RBs for a total of M_{PDSCH}=M_{sc}^{PDSCH}·N_{sc}^{RB} REs for the PDSCH transmission BW.

UL signals can include data signals conveying data information, control signals conveying UL control information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective physical UL shared channel (PUSCH) or a Physical UL control channel (PUCCH). If a UE needs to transmit data information and UCI in a same UL subframe, the UE may multiplex both in a PUSCH. UCI includes Hybrid Automatic Repeat request acknowledgement (HARQ-ACK) information, indicating correct (ACK) or incorrect (NACK) detection for a data TB in a PDSCH or absence of a PDCCH detection (DTX), scheduling request (SR) indicating whether a UE has data in the UE's buffer, rank indicator (RI), and channel state information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH (see also REF 3).

An UL subframe (or slot) includes two slots. Each slot includes N_{symb}^{UL} symbols for transmitting data information, UCI, DMRS, or SRS. A frequency resource unit of an UL system BW is an RB. A UE is allocated N_{RB} RBs for a total of N_{RB}·N_{sc}^{RB} REs for a transmission BW. For a PUCCH, N_{RB}=1. A last subframe (or slot) symbol can be used to multiplex SRS transmissions from one or more UEs. A number of subframe (or slot) symbols that are available for data/UCI/DMRS transmission is N_{symb}=2·(N_{symb}^{UL}−1)−N_{SRS}, where N_{SRS}=1 if a last subframe (or slot) symbol is used to transmit SRS and N_{SRS}=0 otherwise.

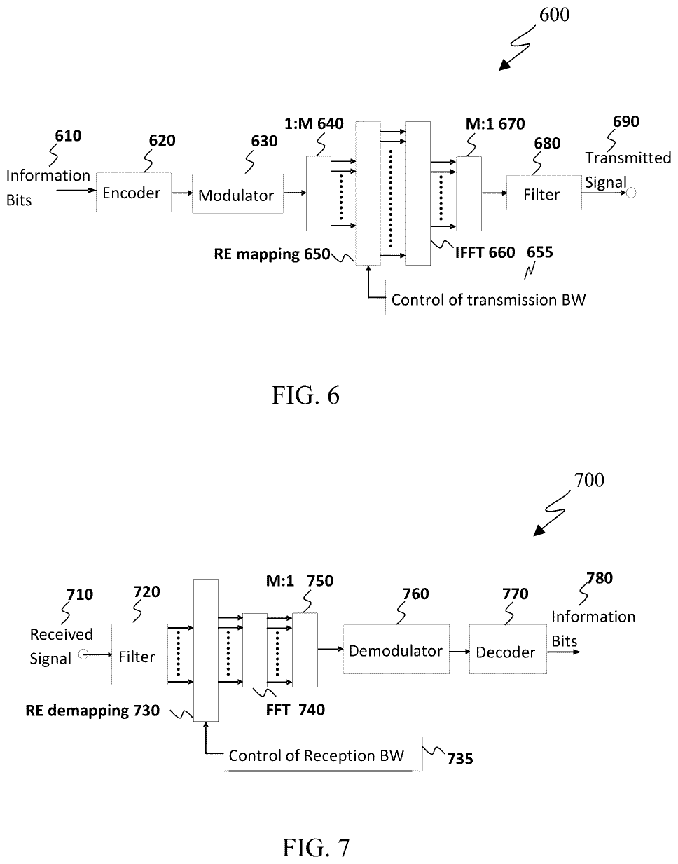

FIG. 6 illustrates a transmitter block diagram 600 for a PDSCH in a subframe according to embodiments of the present disclosure. The embodiment of the transmitter block diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the transmitter block diagram 600.

As shown in FIG. 6, information bits 610 are encoded by encoder 620, such as a turbo encoder, and modulated by modulator 630, for example using quadrature phase shift keying (QPSK) modulation. A serial to parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse fast Fourier transform (IFFT), the output is then serialized by a parallel to serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates a receiver block diagram 700 for a PDSCH in a subframe according to embodiments of the present disclosure. The embodiment of the diagram 700 illustrated in FIG. 7 is for illustration only. One or more of the components illustrated in FIG. 7 can be implemented in specialized circuitry configured to perform the noted functions or one or more of the components can be implemented by one or more processors executing instructions to perform the noted functions. FIG. 7 does not limit the scope of this disclosure to any particular implementation of the diagram 700.

As shown in FIG. 7, a received signal 710 is filtered by filter 720, REs 730 for an assigned reception BW are selected by BW selector 735, unit 740 applies a fast Fourier transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

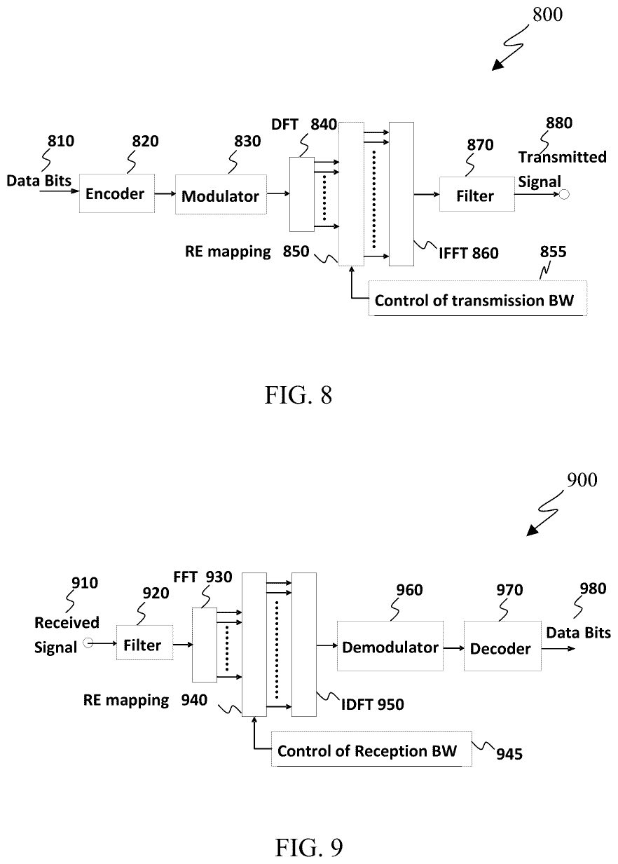

FIG. 8 illustrates a transmitter block diagram 800 for a PUSCH in a subframe according to embodiments of the present disclosure. One or more of the components illustrated in FIG. 7 can be implemented in specialized circuitry configured to perform the noted functions or one or more of the components can be implemented by one or more processors executing instructions to perform the noted functions. The embodiment of the block diagram 800 illustrated in FIG. 8 is for illustration only. FIG. 8 does not limit the scope of this disclosure to any particular implementation of the block diagram 800.

As shown in FIG. 8, information data bits 810 are encoded by encoder 820, such as a turbo encoder, and modulated by modulator 830. A discrete Fourier transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

FIG. 9 illustrates a receiver block diagram 900 for a PUSCH in a subframe according to embodiments of the present disclosure. The embodiment of the block diagram 900 illustrated in FIG. 9 is for illustration only. One or more of the components illustrated in FIG. 9 can be implemented in specialized circuitry configured to perform the noted functions or one or more of the components can be implemented by one or more processors executing instructions to perform the noted functions. FIG. 9 does not limit the scope of this disclosure to any particular implementation of the block diagram 900.

As shown in FIG. 9, a received signal 910 is filtered by filter 920. Subsequently, after a cyclic prefix is removed (not shown), unit 930 applies an FFT, REs 940 corresponding to an assigned PUSCH reception BW are selected by a reception BW selector 945, unit 950 applies an inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown below.

| Frequency range designation | Corresponding frequency range |
|---|---|
| FR1 | 450 MHz-6000 MHz |
| FR2 | 24250 MHz-52600 MHz |

For MIMO in FR1, up to 32 CSI-RS antenna ports is supported, and in FR2, up to 8 CSI-RS antenna ports is supported. In next generation cellular standards (e.g., 6G), in addition to FR1 and FR2, new carrier frequency bands can be considered, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across all antenna ports is possible.

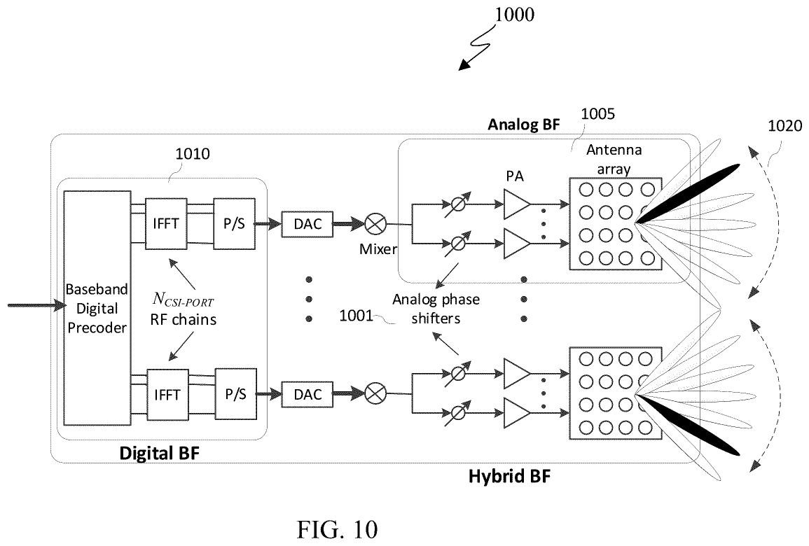

FIG. 10 illustrates an example antenna blocks or arrays 1000 according to embodiments of the present disclosure. The embodiment of the antenna blocks or arrays 1000 illustrated in FIG. 10 is for illustration only. FIG. 10 does not limit the scope of this disclosure to any particular implementation of the antenna blocks or arrays.

In a hybrid analog-digital beamforming, analog beamforming corresponds to a ‘dynamic/varying’ virtualization of multiple antenna elements to obtain one antenna port (or antenna panel). Although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 10. In this case, one CSI-RS port is mapped onto a large number of antenna elements which can be controlled by a bank of analog phase shifters 1001. One CSI-RS port can then correspond to one sub-array which produces a narrow analog beam through analog beamforming 1005. This analog beam can be configured to sweep across a wider range of angles 1020 by varying the phase shifter bank across symbols or subframes (or slots). The number of sub-arrays (equal to the number of RF chains) is the same as the number of antenna ports N_{PORT}. A digital beamforming unit 1010 performs a linear combination across N_{PORT} analog beams to further increase precoding gain. While analog beams are wideband (hence not frequency-selective), digital precoding can be varied across frequency sub-bands or resource blocks. Receiver operation can be conceived analogously.

Embodiments of the present disclosure recognize that in a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For time division duplexing (TDD) systems, the CSI can be acquired using the SRS transmission relying on the channel reciprocity. For frequency division duplexing (FDD systems), on the other hand, it can be acquired using the CSI-RS transmission from eNB (or gNB), and CSI acquisition and feedback from UE. In legacy FDD systems, the CSI feedback framework is ‘implicit’ in the form of CQI/PMI/RI (also CRI and LI) derived from a codebook assuming SU transmission from eNB (or gNB).

In 5G or NR systems [REF7, REF8], the above-mentioned “implicit” CSI reporting paradigm from LTE is also supported and referred to as Type I CSI reporting. In addition, a high-resolution CSI reporting, referred to as Type II CSI reporting, is also supported in Release 15 specification to provide more accurate CSI information to gNB for use cases such as high-order MU-MIMO. However, the overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in REF8). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising all components) needs to be reported by the UE. However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in REF8), wherein the DFT-based SD basis in W₁ is replaced with SD CSI-RS port selection, i.e., L out of

$$\frac{{P}_{CSI - RS}}{2}$$

CSI-RS ports are selected (the selection is common for the two antenna polarizations or two halves of the CSI-RS ports). The CSI-RS ports in this case are beamformed in SD (assuming UL-DL channel reciprocity in angular domain), and the beamforming information can be obtained at the gNB based on UL channel estimated using SRS measurements.

In Rel. 17 NR, CSI reporting has been enhanced to support the following.
Further enhanced Type II port selection codebook: it has been known in the literature that UL-DL channel reciprocity can exist in both angular and delay domains if the UL-DL duplexing distance is small. Since delay in time domain transforms (or closely related to) basis vectors in frequency domain (FD), the Rel. 16 enhanced Type II port selection can be further extended to both angular and delay domains (or SD and FD). In particular, the DFT-based SD basis in W₁ and DFT-based FD basis in W_{f} can be replaced with SD and FD port selection, i.e., L CSI-RS ports are selected in SD and/or M ports are selected in FD. The CSI-RS ports in this case are beamformed in SD (assuming UL-DL channel reciprocity in angular domain) and/or FD (assuming UL-DL channel reciprocity in delay/frequency domain), and the corresponding SD and/or FD beamforming information can be obtained at the gNB based on UL channel estimated using SRS measurements. In Rel. 17, such a codebook is supported (which is referred to as Rel. 17 further enhanced Type II port selection codebook in REF8).
NCJT CSI reporting: When the UE can communicate with multiple TRPs that are distributed at different locations in space (e.g., within a cell), the CSI reporting can correspond to a single TRP hypothesis (i.e., CSI reporting for one of the multiple TRPs), or multi-TRP hypothesis (i.e., CSI reporting for at least two of the multiple TRPs). The CSI reporting for both single TRP and multi-TRP hypotheses are supported in Rel. 17. However, the multi-TRP CSI reporting considers a non-coherent joint transmission (NCJT), i.e., a layer (and precoder) of the transmission is restricted to be transmitted from only one TRP.

In Rel. 18 NR MIMO, the following CSI enhancements are further provided targeting two use cases (coherent joint transmission from multiple TRPs, and high/medium velocity UEs):
Enhancements of CSI acquisition for Coherent-JT targeting FR1 and up to 4 TRPs, assuming ideal backhaul and synchronization as well as the same number of antenna ports across TRPs, as follows:
   Rel-16/17 Type-II codebook refinement for CJT mTRP targeting FDD and its associated CSI reporting, taking into account throughput-overhead trade-off.
CSI reporting enhancement for high/medium UE velocities by exploiting time-domain correlation/Doppler-domain information to assist DL precoding, targeting FR1, as follows:
   Rel-16/17 Type-II codebook refinement, without modification to the spatial and frequency domain basis.
   UE reporting of time-domain channel properties measured via CSI-RS for tracking.

Although Rel-18 CJT CSI can support up to 128 antenna ports by configuring 4 CSI-RS resources each with 32 antenna ports, there is another interest arising to support up to 128 antenna ports using Type-I CSI, which requires smaller feedback overhead than Rel-18 CJT CSI. Currently, a single CSI-RS resource can support up to 32 antenna ports for Type-I single-panel (SP) and multi-panel (MP) CSI. By using multiple CSI-RS resources for Type-I CSI, it is allowed to configure up to 64 antenna ports according to one of the following two schemes:
Two CSI-RS resources each with 32 antenna ports for Rel-17 NCJT (which is Type-I CSI-based).
8 CSI-RS resources each with 8 antenna ports for Type-I SP CSI or Type-I MP CSI

However, both of the schemes do not offer CSI feedback associated with the entire channel of 64 antenna ports, but are designed for specific use cases, 1) NCJT from two TRP, and 2) one CSI-RS resource selection and reporting associated with the selected CSI-RS resource, respectively. Hence, Type-I CSI with more than 32 antenna ports is limited in terms of use cases, and needs some enhancement.

In next generation MIMO systems, the number of antenna ports is expected to increase further (e.g., up to 256), for example, for carrier frequencies in upper mid-band (10-15 GHz); the NW deployments are likely to be denser/more distributed (when compared with 5G NR); and the system is expected to work seamlessly even in challenging scenarios such as medium-high (e.g., 120 kmph) speed UEs, ‘higher-order) multi-user MIMO.

Various embodiments of the present disclosure recognize that similar to legacy (Rel.15/18 NR) both low-resolution (aka Type I) and high-resolution (aka Type II) CSI reporting for the above-mentioned distributed systems are needed and beneficial depending on use cases and scenarios. Unlike legacy, however, it is preferable to have a common framework or components between the two CSI reporting settings, in order to have a simple, future-proof, and scalable solution, thereby making it more feasible in real deployments.

Various embodiments of the present disclosure propose a framework for such CSI reporting that is based on Rel.16 enhanced Type II and Rel.18 Type II CJT codebooks. In particular, based on the proposed framework, several examples are provided to facilitate the low-resolution (aka Type I) CJT CSI reporting across multiple antenna port groups or NZP CSI-RS resources.

The present disclosure relates to a CSI reporting framework in next generation MIMO systems. In particular, it relates to the CSI reporting based on a low-resolution (or Type I) codebook comprising spatial, frequency, and time (Doppler) domain components for a mTRP CJT with distributed antenna structure (DMIMO).

Various embodiments of the present disclosure propose the following: W1: based on Rel.16 eType II and Rel.18 Type II CJT codebooks; W2: based on Rel. 15 Type I (selection and co-phasing); independent vs joint encoding of layers; and relative amp/power across CSI-RS resources, FD/DD compression.

Aspects, features, and advantages of the present disclosure are readily apparent from the following detailed description, simply by illustrating a number of particular embodiments and implementations, including the best mode contemplated for carrying out the disclosure. The present disclosure is also capable of other and different embodiments, and its several details can be modified in various obvious respects, all without departing from the spirit and scope of the present disclosure. Accordingly, the drawings and description are to be regarded as illustrative in nature, and not as restrictive. The present disclosure is illustrated by way of example, and not by way of limitation, in the figures of the accompanying drawings.

In the following, for brevity, both FDD and TDD are provided as the duplex method for both DL and UL signaling.

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This present disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRAB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the M, subbands within the CSI reporting band.

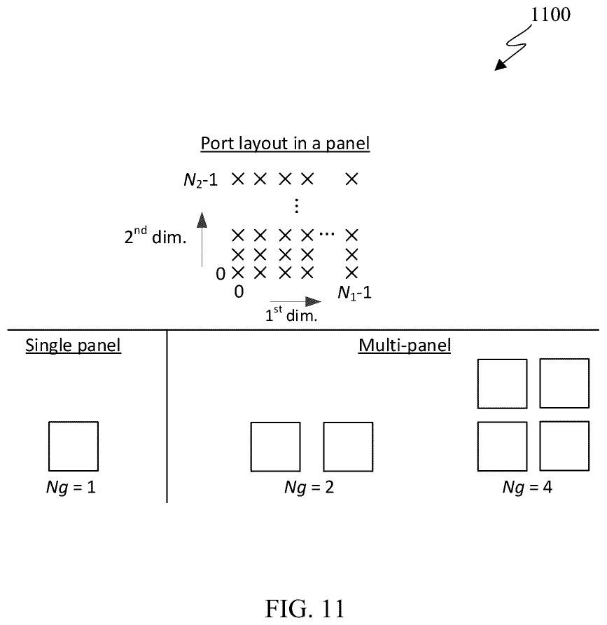

FIG. 11 illustrates an example antenna port layout and antenna group TRP 1100 according to embodiments of the present disclosure. The embodiment of the antenna port layout and antenna group TRP 1100 illustrated in FIG. 11 is for illustration only. FIG. 11 does not limit the scope of this disclosure to any particular implementation of the antenna port layout and antenna group TRP.

As illustrated in FIGS. 11, N₁ and N₂ are the number of antenna ports with the same polarization in the first and second dimensions, respectively. For 2D antenna port layouts, we have N₁>1, N₂>1, and for 1D antenna port layouts N₁>1 and N₂=1 (or N₁=1 and N₂>1). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 11 where “X” represents two antenna polarizations. In this disclosure, the term “polarization” refers to a group of antenna ports with the same polarization. For example, antenna ports j=X+0, X+1, . . . ,

$$X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 ,$$

. . . , X+P_{CSIRS}−1 comprise a second antenna polarization, where P_{CSIRS} is a number of CSI-RS antenna ports and X is a starting antenna port number (e.g., X=3000, then antenna ports are 3000, 3001, 3002, . . . ). Dual-polarized antenna payouts are assumed in this disclosure. The embodiments (and examples) in this disclosure however are general and are applicable to single-polarized antenna layouts as well.

Let N_{g} be a number of antenna groups (AGs). When there are multiple antenna groups (N_{g}>1), we assume that each group (g∈{1, . . . , N_{g}}) comprises dual-polarized antenna ports with N_{1,g} and N_{2,g} ports in two dimensions. This is illustrated in FIG. 11. Note that the antenna port layouts may be the same (N_{1,g}=N₁ and N_{2,g}=N₂) in different antenna groups, or they can be different across antenna groups. For group g, the number of antenna ports is P_{CSIRS,g}=N_{1,g}N_{2,g} or 2N_{1,g}N_{2,g} (for co-polarized or dual-polarized respectively).

In one example, an antenna group corresponds to an antenna panel. In one example, an antenna group corresponds to a TRP. In one example, an antenna group corresponds to an RRH. In one example, an antenna group corresponds to CSI-RS antenna ports of a NZP CSI-RS resource. In one example, an antenna group corresponds to a subset of CSI-RS antenna ports of a NZP CSI-RS resource (comprising multiple antenna groups). In one example, an antenna group corresponds to CSI-RS antenna ports of multiple NZP CSI-RS resources (e.g., comprising a CSI-RS resource set).

In one example, an antenna group corresponds to a reconfigurable intelligent surface (RIS) in which the antenna group can be (re-) configured more dynamically (e.g., via MAC CE and/or DCI). For example, the number of antenna ports associated with the antenna group can be changed dynamically.

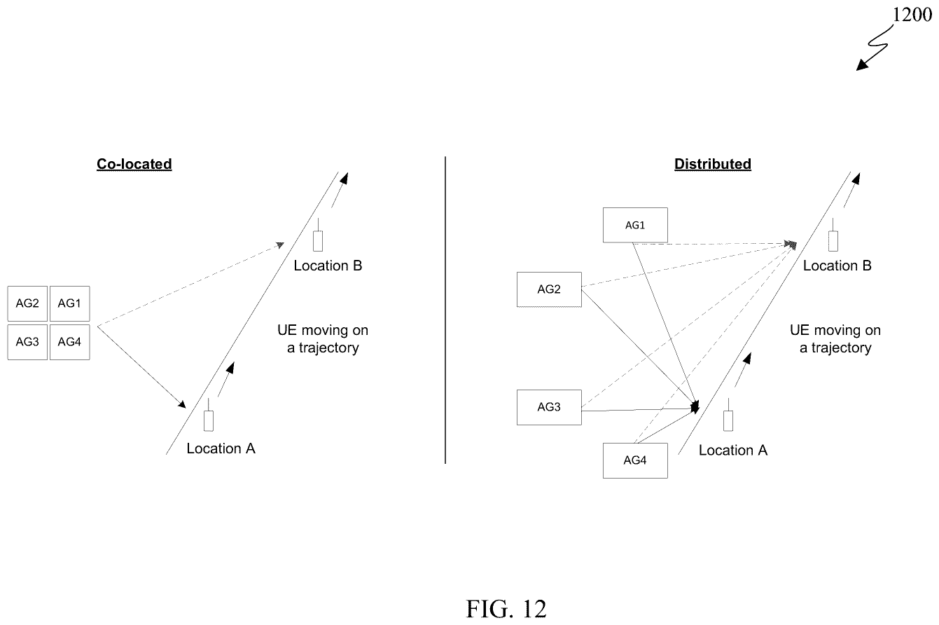

FIG. 12 illustrates co-located and distributed antenna groups (AGs) serving a moving UE 1200 according to embodiments of the present disclosure. The embodiment of the co-located and distributed antenna groups (AGs) serving a moving UE 1200 illustrated in FIG. 12 is for illustration only. FIG. 12 does not limit the scope of this disclosure to any particular implementation of the co-located and distributed antenna groups (AGs) serving a moving UE 1200.

In one example scenario, multiple AGs can be co-located or distributed, and can serve static (non-mobile) or moving UEs. An illustration of AGs serving a moving UE is shown in FIG. 12. While the UE moves from a location A to another location B, the UE measures the channel, e.g., via NZP CSI-RS resources, (may also measure the interference, e.g., via CSI-IM resources or CSI-RS resources for interference measurement), uses the measurement to determine/report CSI considering joint transmission from multiple AGs. The reported CSI can be based on a codebook. The codebook can include components considering multiple AGs, and frequency/delay-domain channel profile and time/Doppler-domain channel profile.

In one example, the antenna architecture of the MIMO system is structured. For example, the antenna structure at each AG is dual-polarized (single or multi-panel as shown in FIG. 11. The antenna structure at each AG can be the same. Or the antenna structure at an AG can be different from another AG. Likewise, the number of ports at each AG can be the same. Or, the number of ports at one AG can be different from another AG.

In another example, the antenna architecture of the MIMO system is unstructured. For example, the antenna structure at one AG can be different from another AG.

We assume a structured antenna architecture in the rest of the disclosure. For simplicity, we assume each AG is equivalent to a panel (cf. FIG. 11), although, an AG can have multiple panels in practice. The disclosure however is not restrictive to a single panel assumption at each AG, and can easily be extended (covers) the case when an AG has multiple antenna panels.

In one embodiment, an AG constitutes (or corresponds to or is equivalent to) at least one of the following:
In one example, an AG corresponds to a TRP.
In one example, an AG corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure.
In one example, an AG corresponds to a CSI-RS resource group, where a group comprises one or multiple NZP CSI-RS resources. A UE is configured with K≥ N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an AG corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an AG. The information about the subsets of ports or grouping of ports can be provided together with the CSI-RS resource setting/configuration, or with the CSI reporting setting/configuration, or with the CSI-RS resource configuration.
In one example, an AG corresponds to one or more examples described herein depending on a configuration. For example, this configuration can be explicit via a parameter (e.g., an RRC parameter). Or, it can be implicit.
   In one example, when implicit, it could be based on the value of K. For example, when K>1 CSI-RS resources, an AG corresponds to one or more examples described herein, and when K=1 CSI-RS resource, an AG corresponds to one or more examples described herein.
   In another example, the configuration could be based on the configured codebook. For example, an AG corresponds to a CSI-RS resource or resource group when the codebook corresponds to a decoupled codebook (modular or separate codebook for each AG), and an AG corresponds to a subset (or a group) of CSI-RS ports when codebook corresponds to a coupled (joint or coherent) codebook (one joint codebook across AGs).

In one example, when an AG maps (or corresponds to) a CSI-RS resource or resource group, and a UE can select a subset of AGs (resources or resource groups) and report the CSI for the selected AGs (resources or resource groups), the selected AGs can be reported via an indicator. For example, the indicator can be a CRI or a PMI (component) or a new indicator.

In one example, when an AG maps (or corresponds to) a CSI-RS port group, and a UE can select a subset of AGs (port groups) and report the CSI for the selected AGs (port groups), the selected AGs can be reported via an indicator. For example, the indicator can be a CRI or a PMI (component) or a new indicator.

In one example, when multiple (K>1) CSI-RS resources are configured for N_{g} AGs, a decoupled (modular) codebook is used/configured, and when a single (K=1) CSI-RS resource for N_{g} AGs, a joint codebook is used/configured.

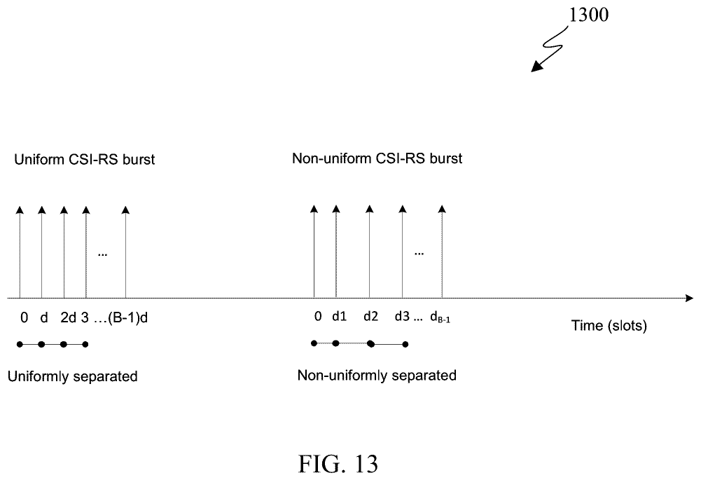

FIG. 13 illustrates an example of a UE configured to receive a burst of non-zero power (NZP) CSI reference signal (CSI-RS) resources 1300 according to embodiments of the present disclosure. The embodiment of the UE configured to receive a burst of non-zero power (NZP) CSI reference signal (CSI-RS) resources 1300 illustrated in FIG. 13 is for illustration only. FIG. 1300 does not limit the scope of this disclosure to any particular implementation of the UE configured to receive a burst of non-zero power (NZP) CSI reference signal (CSI-RS) resources 1300.

In one embodiment, as shown in FIG. 13, a UE is configured to receive a burst of non-zero power (NZP) CSI-RS resource(s), referred to as CSI-RS burst for brevity, within B time slots comprising a measurement window, where B≥1. The B time slots can be accordingly to at least one of the following examples.
In one example, the B time slots are evenly/uniformly spaced with an inter-slot spacing d.
In one example, the B time slots can be non-uniformly spaced with inter-slot spacing e₁=d₁, e₂=d₂−d₁, e₃=d₃−d₂, . . . , so on, where eᵢ≠eⱼ for at least one pair (i,j) with i≠j.

The UE receives the CSI-RS burst, estimates the B instances of the DL channel measurements, and uses the channel estimates to obtain the Doppler component(s) of the DL channel. The CSI-RS burst can be linked to (or associated with) a single CSI reporting setting (e.g., via higher layer parameter CSI-ReportConfig), wherein the corresponding CSI report includes an information about the Doppler component(s) of the DL channel.

Let hₜ be the DL channel estimate based on the CSI-RS resource(s) received in time slot t∈{0, 1, . . . , B−1}. When the DL channel estimate in slot t is a matrix Gₜ of size N_{Rx}×N_{Tx}×N_{Sc}, then hₜ=vec(Gₜ), where N_{Rx}, N_{Tx}, and N_{Sc} are number of receive (Rx) antennae at the UE, number of CSI-RS ports measured by the UE, and number of subcarriers in frequency band of the CSI-RS burst, respectively. The notation vec (X) is used to denote the vectorization operation wherein the matrix X is transformed into a vector by concatenating the elements of the matrix in an order, for example, 1→2→3→ and so on, implying that the concatenation starts from the first dimension, then moves second dimension, and continues until the last dimension. Let H_{B}=[h₀ h₁ . . . h_{B-1}] be a concatenated DL channel. The Doppler component(s) of the DL channel can be obtained based on H B. For example, H_{B} can be represented as CΦ^{H}=Σ_{S=0}^{N-1}cₛΦₛ^{H} where Φ=[ϕ₀ ϕ₁ . . . ϕ_{N-1}] is a Doppler domain (DD) basis matrix whose columns comprise basis vectors, C=[c₀ c₁ . . . c_{N-1}] is a coefficient matrix whose columns comprise coefficient vectors, and N<B is the number of DD basis vectors. Since the columns of H_{B} are likely to be correlated, a DD compression can be achieved when the value of N is small (compared to the value of B). In this example, the Doppler component(s) of the channel is represented by the DD basis matrix Φ and the coefficient matrix C.

When there are multiple TRPs/RRHs (N_{TRP}>1), the UE can be configured to measure the CSI-RS burst(s) according to at least one of the following examples.

In one example, the UE is configured to measure N_{TRP} CSI-RS bursts, one from each TRP/RRH. The N_{TRP} CSI-RS bursts can be overlapping in time (i.e., measured in same time slots). Or, they can be staggered in time (i.e., measured in different time slots). Whether overlapping or staggered can be determined based on configuration. It can also depend on the total number of CSI-RS ports across RRHs/TRPs. When the total number of ports is small (e.g., <=32), they can overlap, otherwise (>32), they are staggered. The number of time instances B can be the same for all of the N_{TRP} bursts. Or the number B can be the same or different across bursts (or TRPs/RRHs).
In one example, each CSI-RS burst corresponds to a semi-persistent (SP) CSI-RS resource. The SP CSI-RS resource can be activated and/or deactivated based on a MAC CE and/or DCI based signaling.
In one example, each CSI-RS burst corresponds to a group of B≥1 aperiodic (Ap) CSI-RS resources. The Ap-CSI-RS resources can be triggered via a DCI with slot offsets such that they can be measured in B different time slots.
In one example, each CSI-RS burst corresponds to a periodic (P) CSI-RS resource. The P-CSI-RS resource can be configured via higher layer. The first measurement instance (time slot) and the measurement window of the CSI-RS burst (from the P-CSI-RS resource) can be fixed, or configured.
In one example, a CSI-RS burst can either be a P-CSI-RS, or SP-CSI-RS or Ap-CSI-RS resource.
   In one example, the time-domain behavior (P, SP, or Ap) of N_{TRP} CSI-RS bursts is the same.
   In one example, the time-domain behavior of N_{TRP} CSI-RS bursts can be the same or different.

In one example, the UE is configured to measure K≥N_{TRP} CSI-RS bursts, where K=>N_{TRP} K, and Kᵣ is a number of CSI-RS bursts associated with RRH/TRP r, where r∈{1, . . . , N_{TRP}}. Each CSI-RS burst is according to at least one of the examples in example A.1.1. When Kᵣ>1, multiple CSI-RS bursts are linked to (or associated with) a CSI reporting setting, i.e., the UE receives the Nᵣ CSI-RS bursts, estimates the DL channels, and obtains the Doppler component(s) of the channel using all of the Nᵣ CSI-RS bursts.

In one example, the UE is configured to measure one CSI-RS burst across all of N_{TRP} TRPs/RRHs. Let P be a number of CSI-RS ports associated with the NZP CSI-RS resource measured via the CSI-RS burst. The CSI-RS burst is according to at least one of the examples in described herein. The total of P ports can be divided into N_{TRP} groups/subsets of ports and one N_{TRP} P, and group/subset of ports is associated with (or corresponds to) a TRP/RRH. Then, P=Σᵣ₌₁^{N}^{_{TRP}} Pᵣ is a number of CSI-RS ports in the group/subset of ports associated with RRH/TRP r.
In one example, in each of the B time instances, a UE is configured to measure all groups/subsets of ports, i.e., in each time instance within the burst, the UE measures all of P ports (or N_{TRP} groups/subsets of ports).
In one example, a UE is configured to measure subsets/groups of ports across multiple time instances, i.e., in each time instance within the burst, the UE measures a subset of P ports or a subset of groups of ports (RRHs/TRPs).
   In one example, in each time instance, the UE measures only one group/subset of ports (1 TRP per time instance). In this case, B=N_{TRP}×C or B≥N_{TRP}×C, where C is a number of measurement instances for each TRP/RRH.
   In one example, the UE is configured to measure one half of the port groups in a time instance, and the remaining half in another time instance.
      In one example, the two time instances can be consecutive, for example, the UE measures one half of port groups in even-numbered time instances, and the remaining half in the odd-numbered time instances.
      In one example, a first half of the time instances (e.g., 0, 1, . . . ,

$$\frac{B}{2} - 1 )$$

is configured to measure one half of the port groups, and the second half of the time instances (e.g., B/2, . . . B−1) is configured to measure the remaining half of the port groups.

In one example, the UE is configured to measure multiple CSI-RS bursts, where each burst is according to at least one of the examples described herein. Multiple CSI-RS bursts are linked to (or associated with) a CSI reporting setting, i.e., the UE receives multiple CSI-RS bursts, estimates the DL channels, and obtains the Doppler component(s) of the channel using all of multiple CSI-RS bursts.

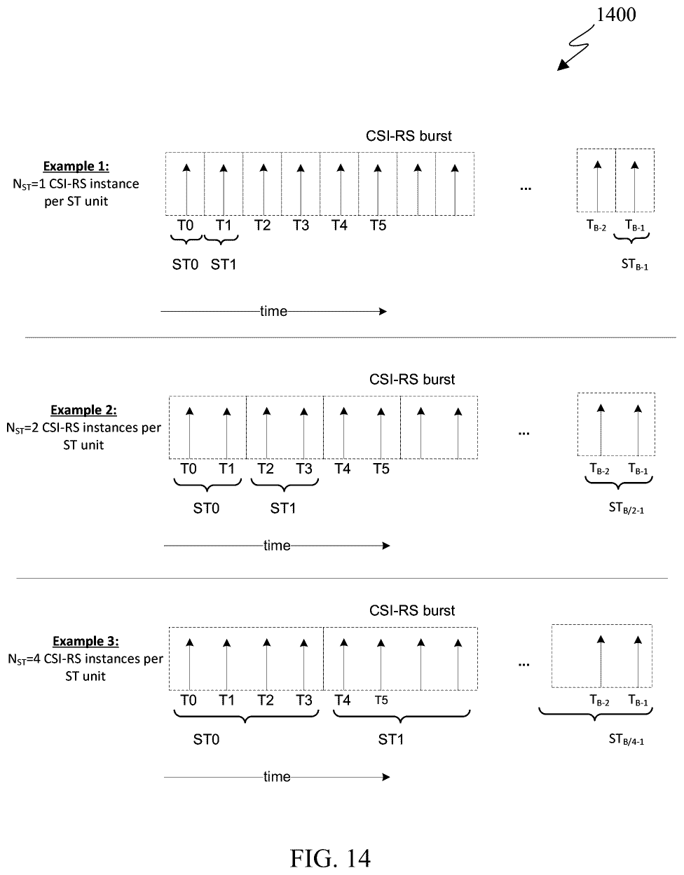

FIG. 14 illustrates an example of a UE configured to determine a value of N₄ based on the value B in a CSI-RS burst 1400 according to embodiments of the present disclosure. The embodiment of the UE configured to determine a value of N₄ based on the value B in a CSI-RS burst 1400 illustrated in FIG. 14 is for illustration only. FIG. 14 does not limit the scope of this disclosure to any particular implementation of the UE configured to determine a value of N₄ based on the value B in a CSI-RS burst 1400.

Let N₄ be the length of the DD basis vectors {ϕₛ}, e.g., each basis vector is a length N₄×1 column vector.

In one embodiment, a UE is configured to determine a value of N₄ based on the value B (number of CSI-RS instances) in a CSI-RS burst and components across which the DD compression is performed, where each component corresponds to one or multiple time instances within the CSI-RS burst. In one example, N₄ is fixed (e.g., N₄=B) or configured (e.g., via RRC or MAC CE or DCI) or reported by the UE (as part of the CSI report). In one example, the B CSI-RS instances can be partitioned into sub-time (ST) units (instances), where each ST unit is defined as (up to) N_{ST} contiguous time instances in the CSI-RS burst. In this example, a component for the DD compression corresponds to a ST unit. Three examples of the ST units are shown in FIG. 14. In the first example, each ST unit comprises N_{ST}=1 time instance in the CSI-RS burst. In the second example, each ST unit comprises N_{ST}=2 contiguous time instances in the CSI-RS burst. In the third example, each ST unit comprises N_{ST}=4 contiguous time instances in the CSI-RS burst.

The value of N_{ST} can be fixed (e.g., N_{ST}=1 or 2 or 4) or indicated to the UE (e.g., via higher layer RRC or MAC CE or DCI based signaling) or reported by the UE (e.g., as part of the CSI report). The value of N_{ST} (fixed or indicated or reported) can be subject to a UE capability reporting. The value of N_{ST} can also be dependent on the value of B (e.g., one value for a range of values for B and another value for another range of values for B).

When there are multiple TRPs/RRHs (N_{TRP}>1), the UE can be configured to determine a value of N₄ according to at least one of the following examples.

In one example, a value of N₄ is the same for all TRPs/RRHs.

In one example, a value of N₄ can be the same or different across TRPs/RRHs.

In one embodiment, a UE is configured with J≥1 CSI-RS bursts (as illustrated earlier in the disclosure) that occupy a frequency band and a time span (duration), wherein the frequency band comprises A RBs, and the time span comprises B time instances (of CSI-RS resource(s)). When J>1, the A RBs and/or B time instances can be aggregated across J CSI-RS bursts. In one example, the frequency band equals the CSI reporting band and the time span equals the number of CSI-RS resource instances (across) CSI-RS bursts), both can be configured to the UE for a CSI reporting, which can be based on the DD compression.

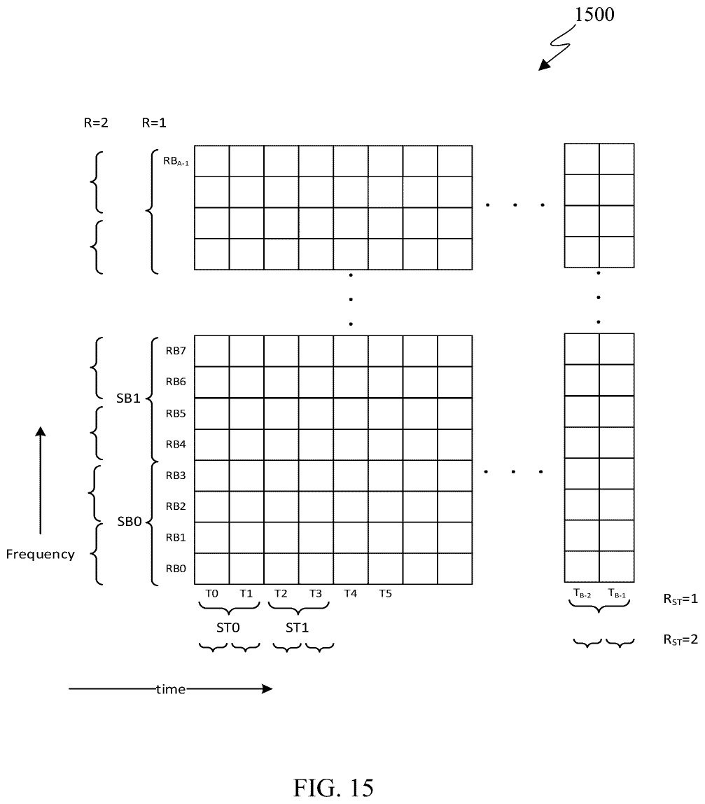

FIG. 15 illustrates an example of a UE configured to partition the A RBs into subbands (SBs) and/or the B time instances into sub-times (STs) 1500 according to embodiments of the present disclosure. The embodiment of the UE configured to partition the A RBs into subbands (SBs) and/or the B time instances into sub-times (STs) 1500 illustrated in FIG. 15 is for illustration only. FIG. 15 does not limit the scope of this disclosure to any particular implementation of the UE configured to partition the A RBs into subbands (SBs) and/or the B time instances into sub-times (STs) 1500.

The UE is further configured to partition (divide) the A RBs into subbands (SBs) and/or the B time instances into sub-times (STs). The partition of A RBs can be based on a SB size value N_{SB}, which can be configured to the UE (cf. Table 5.2.1.4-2 of REF8). The partition of B time instances can be based either a ST size value N_{ST} or an r value, as described in this disclosure. An example is illustrated in FIG. 15, where RB0, RB1, . . . , RB_{A-1} comprise A RBs, T₀, T₁, . . . , T_{B-1} comprise B time instances, the SB size N_{SB}=4, and the ST size N_{ST}=2.

When there are multiple TRPs/RRHs (N_{TRP}>1), the UE can be configured to determine subbands (SBs) and/or sub-times (STs) according to at least one of the following examples.
In one example, both subbands (SBs) and/or sub-times (STs) are the same for all TRPs/RRHs.
In one example, subbands (SBs) are the same for all TRPs/RRHs, but sub-times (STs) can be the same or different across RRHs/TRPs.
In one example, sub-times (STs) are the same for all TRPs/RRHs, but subbands (SBs) can be the same or different across RRHs/TRPs.
In one example, both sub-times (STs) and subbands (SBs) can be the same or different across RRHs/TRPs.

For illustration, both subbands (SBs) and/or sub-times (STs) being the same for all TRPs/RRHs is assumed in the rest of this disclosure.

The CSI reporting is based on channel measurements (based on CSI-RS bursts) in three-dimensions (3D): the first dimension corresponds to SD comprising P_{CSIRS} CSI-RS antenna ports (in total across all of N_{TRP} RRHs/TRPs), the second dimension corresponds to FD comprising N₃ FD units (e.g., SB), and the third dimension corresponds to DD comprising N₄ DD units (e.g., ST). The 3D channel measurements can be compressed using basis vectors (or matrices) similar to the Rel. 16 enhanced Type II codebook. Let W₁, W_{f}, and W_{d} respectively denote basis matrices whose columns comprise basis vectors for SD, FD, and DD.

In one embodiment, the DD compression (or DD component or W_{d} basis) can be turned OFF/ON from the codebook. When turned OFF, W_{d} can be fixed (hence not reported), e.g., W_{d}=1 (scalar 1) or W_{d}=[1, . . . , 1] (all-one vector) or

$${W}_{d} = \frac{1}{n} [ 1 , … , 1 ]$$

(all-one vector) or

$${W}_{d} = I = [ \begin{matrix}1 & 0 & 0 \\ 0 & ⋱ & 0 \\ 0 & 0 & 1\end{matrix} ]$$

(identity matrix), where n is a scaling factor (e.g., n=N₄) or

$${W}_{d} = {h}_{{d}^{*}} = [ \begin{matrix}{ϕ}_{0}^{( {d}^{*} )} & {ϕ}_{1}^{( {d}^{*} )} & … & {ϕ}_{{N}_{4} - 1}^{( {d}^{*} )} ] ,\end{matrix}$$

where d* is an index of a fixed DD basis vector h_{d*}. In one example, d*=0. In one example, when the DD basis vectors comprise an orthogonal DFT basis set, hat is a DD basis vector which corresponds to the DC component. When turned ON, W_{d} (DD basis vectors) is reported.
In one example, W_{d} is turned OFF/ON via an explicit signaling, e.g., an explicit RRC parameter.
In one example, W_{d} is turned OFF/ON via a codebook parameter. For example, similar to M=1 in Rel.17, when N=1 is configured, W_{d} is turned OFF, and when a value N>1 is configured, W_{d} is turned ON. Here, N denotes a number of DD basis vectors comprising columns of W_{d}.
In one example, the UE reports whether the DD component is turned OFF (not reported) or ON (reported). This reporting can be via a dedicated parameter (e.g., new UCI/CSI parameter). Or, this reporting can be via an existing parameter (e.g., PMI component). A two-part UCI (cf. Rel. 15 NR) can be reused wherein the information whether W_{d} is turned OFF/ON is included in UCI part 1.
In one example, W_{d} is turned OFF/ON depending on the codebookType. When the codebookType is regular Type II codebook (similar to Rel 16 Type II codebook), W_{d} is turned ON, and when the codebookType is Type II port selection codebook (similar to Rel 17 Type II codebook), W_{d} is turned ON/OFF.

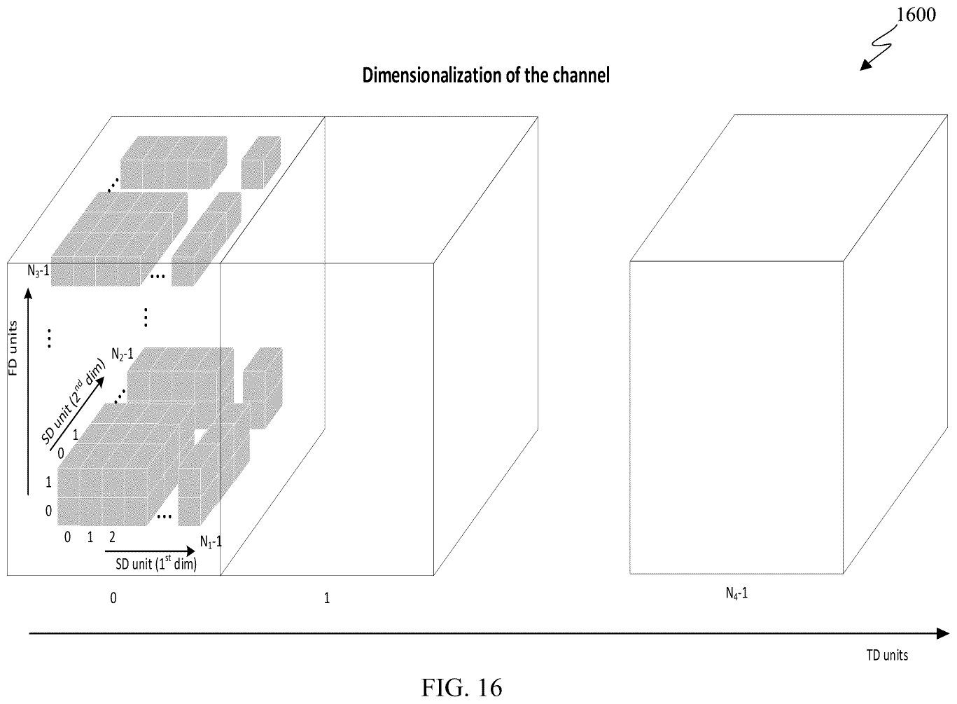

FIG. 16 illustrates SD units (in 1^{st} and 2^{nd} antenna dimensions), FD units, and TD units 1600 according to embodiments of the present disclosure. The embodiment of the SD units, FD units, and TD units 1600 illustrated in FIG. 16 is for illustration only. FIG. 16 does not limit the scope of this disclosure to any particular implementation of the SD units, FD units, and TD units 1600.

In one embodiment, a UE is configured (e.g., via a higher layer CSI configuration information) with a CSI report, where the CSI report is based on a channel measurement (and interference measurement) and a codebook. When the CSI report is configured to be aperiodic, it is reported when triggered via a DCI field (e.g., a CSI request field) in a DCI.

The channel measurement can be based on K≥1 channel measurement resources (CMRs) that are transmitted from a plurality of spatial-domain (SD) units (e.g., a SD unit=a CSI-RS antenna port), and are measured via a plurality of frequency-domain (FD) units (e.g., a FD unit=one or more PRBs/SBs) and via either a time-domain (TD) unit or a plurality of TD units (e.g., a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) and/or a second set of TD units (different from the plurality of TD units associated with the channel measurement). In this later case, the UE, based on the channel measurement, can perform prediction (interpolation or extrapolation) in the second set of FD units and/or the second set of TD units associated with the CSI report.

An illustration of the SD units (in 1^{st} and 2^{nd} antenna dimensions), FD units, and, and TD units is shown in FIG. 16.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

### On SD Units

The plurality of SD units can be associated with antenna ports (e.g., co-located at one site or distributed across multiple sites) comprising one or multiple antenna groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one AG comprising all P_{CSIRS} ports, and the CSI report is based on the channel measurement from the one AG.
When N_{g}>1, there are multiple AGs, and the CSI report is based on the channel measurement from/across the multiple AGs.

When K>1, there are multiple CMRs, and the CSI report is based on the channel measurement across the multiple CMRs. In one example, a CMR corresponds to an AG (one-to-one mapping). In one example, multiple CMRs can correspond to an AG (many-to-one mapping). In one example, when all of the P_{CSIRS} antenna ports are co-located at one site, N_{g}=1. In one example, when all of the P_{CSIRS} antenna ports are distributed (non-co-located) across multiple sites, N_{g}>1.

In one example, when all of the P_{CSIRS} antenna ports are co-located at one site and within a single antenna panel, N_{g}=1. In one example, when all of the P_{CSIRS} antenna ports are distributed across multiple antenna panels (can be co-located or non-co-located), N_{g}>1.

The value of N_{g} can be configured, e.g., via higher layer RRC parameter. Or it can be indicated via a MAC CE. Or it can be provided via a DCI field.

Likewise, the value of K can be configured, e.g., via higher layer RRC parameter. Or it can be indicated via a MAC CE. Or it can be provided via a DCI field.

In one example, K=N_{g}=X. The value of X can be configured, e.g., via higher layer RRC parameter. Or it can be indicated via a MAC CE. Or it can be provided via a DCI field.

In one example, the value of K is determined based on the value of N_{g}. In one example, the value of N_{g} is determined based on the value of K.

### On FD Units

The plurality of FD units can be associated with a frequency domain allocation of resources (e.g., one or multiple CSI reporting bands, each comprising multiple PRBs) and dimensionalizes the frequency (or delay)-domain profile of the channel measurement.

### On TD/DD Units

The plurality of TD units can be associated with a time domain allocation of resources (e.g., one or multiple CSI reporting windows, each comprising multiple time slots) and dimensionalizes the time (or Doppler)-domain profile of the channel measurement.

### Component I

The CSI report includes an information about a precoding matrix (e.g., the information is an indicator such as PMI). The information about the precoding matrix comprises/includes at least two components (W₁ and W₂). The first component (W₁) includes a basis which corresponds to a set of basis entities. The second component (W₂) includes
For low-resolution (Type I), selection of a basis entity from the basis entities (per layer) and co-phasing across two polarizations.
For high-resolution (Type II), combining coefficients which linearly combine the basis entities, i.e., the precoding matrix can be represented as a weighted summation over the basis entities, where the weights are the combining coefficients.

The first component W₁ is codebook-based. When the basis needs reporting (or configured to be reported), the codebook configured for the CSI report includes at least one component for reporting the basis W₁. This component is similar to legacy (e.g., Type I and II codebooks in 5G NR) codebooks. However, since W₁ is decoupled from W₂, the framework allows more options and parameterization for the W₁ basis as future upgrades when newer antenna types become available. The basis can be dictated by (or associated with) at least one of the spatial-domain profile, frequency (or delay)-domain profile, or time (Doppler)-domain profile of the channel measurement. Even though the number of CSI-RS antenna ports can be large (e.g., 256), the antenna ports are expected to have some antenna structure (e.g., similar to 2D active antenna array), hence the SD channel profile can be represented using SD basis entities, where the SD basis entities have dimension depending on the number of SD units (P_{CSIRS} or P_{CSIRS}/2 or 2N₁N₂ or N₁N₂). Likewise, the FD channel profile is likely to be correlated across FD units, and the DD/TD channel profile is also expected to have some correlation across DD/TD units (e.g., for low-medium speed UEs). Hence, FD and DD/TD channel profiles can be represented using FD and DD/TD basis entities, respectively, where their dimensions depend on the number of FD units (N₃) and the number of DD/TD units (N₄), respectively.

The second component (W₂) is also codebook-based and is derived based on the channel measurement and W₁. For instance, the channel measurement can be projected on to the basis W₁ and projected channel can be used to derive the W₂ components (coefficients), e.g., based on Type I or Type II codebooks in 5G NR.

In one example, the number of antenna ports across K CSI-RS resources is the same. For example, each of the K CSI-RS resources can be associated with 2N₁N₂ antenna ports. In this case, the total number of antenna ports is P_{CSIRS,tot}=2N₁N₂.

In one example, the number of antenna ports across K CSI-RS resources can be the same or different. For example, each of the K CSI-RS resources can be associated with 2N_{1,r}N_{2,r} antenna ports. In this case, the total number of antenna ports is P_{CSIRS,tot}=Σᵣ₌₁^{K}2N_{1,r}N_{2,r}.

In port numbering scheme 1, the CSI-RS ports are numbered according to the order of (polarization p, NZP CSI-RS resource r) as CSI-RS ports of (p=0,r=1) followed by CSI-RS ports of (p=1,r=1), followed by CSI-RS ports of (p=0,r=2), followed by CSI-RS ports of (p=1,r=2), . . . , followed by CSI-RS ports of (p=0,r=N) followed by CSI-RS ports of (p=1,r=N).

In port numbering scheme 2, the CSI-RS ports are numbered according to the order of (polarization p, NZP CSI-RS resource r) as
CSI-RS ports of (p=0,r=1) followed by CSI-RS ports of (p=0,r=1), . . . , followed by CSI-RS ports of (p=0,r=N), and
then CSI-RS ports of (p=1,r=1) followed by CSI-RS ports of (p=1,r=1), . . . , followed by CSI-RS ports of (p=1,r=N).

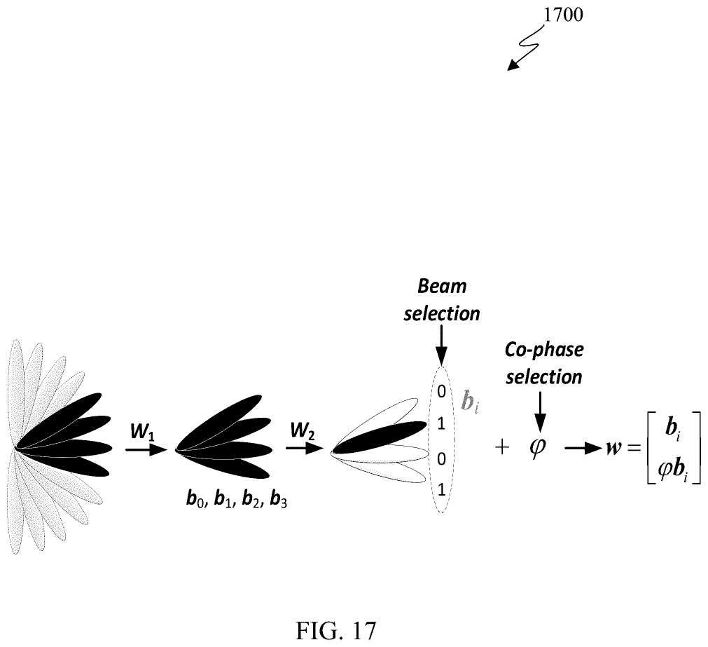

FIG. 17 illustrates examples of W1 and W2 1700 according to embodiments of the present disclosure. The embodiment of the examples of W1 and W2 1700 illustrated in FIG. 17 is for illustration only. FIG. 17 does not limit the scope of this disclosure to any particular implementation of the examples of W1 and W2 1700.

### Embodiments on CB Based on Type II W1 and Type I W2

In one embodiment, a UE is configured with a CSI report associated with (or across) N≥1 NZP CSI-RS resources (or N≥1 subsets of CSI-RS antenna ports or antenna port groups within a NZP CSI-RS resource), the CSI report is determined based on a codebook comprising components corresponding to W₁ and W₂. In particular, the precoder for layer l is given by

$${W}_{l} = \frac{1}{γ} {W}_{1} {W}_{2}$$

### Here,

W is a P_{CSIRS}×1 vector, where P_{CSIRS}=>Nᵣ₌₁^{N}2N_{1,r}N_{2,r}
W₁ is a block diagonal matrix comprising 2N blocks, where two blocks are associated with two antenna polarizations (two halves or groups of CSI-RS antenna ports) of each NZP CSI-RS resource and each block is a

$$\frac{{P}_{CSIRS , r}}{2} \times {L}_{r}$$

SD basis or port selection matrix (similar to Rel. 16/18 Type II or Type II CJT codebook or Rel. 17/18 Type II port selection (PS) or CJT PS codebook)
W₂ is a 2L×2N coefficients matrix, where L=Σᵣ₌₁^{N}Lᵣ, and
γ is a normalization factor.

In one example, N≤K and K is a number of NZP CSI-RS resources (e.g., in a CSI resource set) configured for channel measurements. In one example, K is fixed (e.g., 2 or 3 or 4) or configured (e.g., via higher layer from {2,3,4} or {1,2,3,4}), or reported by the UE (e.g., as part of UE capability). In one example, the value of N can be ≥1. In one example, the value of N can be ≥2. In one example, the value of N is configured (e.g., via higher layer). In one example, the value of N is reported by the UE (e.g., as part of the CSI report). In one example, the UE is configured with N=K (i.e., no selection of NZP CSI-RS resources) or N≤K (i.e., dynamic selection of NZP CSI-RS resources by the UE). When the UE performs dynamic selection, the selected N NZP CSI-RS resources can be reported via part 1 of the two part CSI (or UCI). The reporting can be via a bitmap indicator of size K bits.

As shown in FIG. 17, at least one of the following examples is used/configured regarding W₁ and W₂.

In one example, for port numbering scheme 1, W₁ is a block diagonal matrix

$$[ \begin{matrix}{W}_{1 , 1} & 0 & 0 & 0 \\ 0 & ⋱ & 0 & 0 \\ 0 & 0 & & \\ 0 & 0 & & {W}_{1 , 2 N}\end{matrix} ]$$

comprising 2N blocks, (2(r−1)+1,2r)-th blocks, W_{1,2(r-1)+1} and W_{1,2r}, are associated with two antenna polarizations (two halves or groups of CSI-RS antenna ports) of the NZP CSI-RS resource r, and W₂ is a block matrix

$$[ \begin{matrix}{W}_{2 , 1} \\ {W}_{2 , 2} \\ ⋮ \\ {W}_{2 , 2 N}\end{matrix} ]$$

$$and$$

$$[ \begin{matrix}{W}_{2 , 2 ( r - 1 ) + 1} \\ {W}_{2 , 2 r}\end{matrix} ] = {W}_{2 , r , 1} {W}_{2 , r , 2} = [ \begin{matrix}{e}_{{j}_{r}}^{{L}_{r}} & 0 \\ 0 & {e}_{{j}_{r}}^{{L}_{r}}\end{matrix} ] [ \begin{matrix}1 \\ {c}_{r}\end{matrix} ] = [ \begin{matrix}{e}_{{j}_{r}}^{{L}_{r}} \\ {c}_{r} {e}_{{j}_{r}}^{{L}_{r}}\end{matrix} ] , {e}_{{j}_{r}}^{{L}_{r}}$$

is a Lᵣ-element column (selection) vector containing a value of 1 in element jᵣ or (jᵣ mod Lᵣ) and zeros elsewhere, and cᵣ is a coefficient. Note that when Lᵣ=1,

$${W}_{2 , r , 1} = [ \begin{matrix}1 & 0 \\ 0 & 1\end{matrix} ] ,$$

hence eⱼ_{ᵣ}^{L}^{ᵣ} does not need reporting. Hence, eⱼ_{ᵣ}^{L}^{ᵣ} is reported when Lᵣ>1.

In one example, for port numbering scheme 2, W1 is a block diagonal matrix

$$[ \begin{matrix}{W}_{1 , 1} & 0 & 0 & 0 \\ 0 & ⋱ & 0 & 0 \\ 0 & 0 & & \\ 0 & 0 & & {W}_{1 , 2 N}\end{matrix} ]$$

comprising 2N blocks, where (r,r+N)-th blocks, W_{1,r} and W_{1,r+N}, are associated with two antenna polarizations (two halves or groups of CSI-RS antenna ports) of the NZP CSI-RS resource r, and W₂ is a block matrix

$$[ \begin{matrix}{W}_{2 , 1} \\ {W}_{2 , 2} \\ ⋮ \\ {W}_{2 , 2 N}\end{matrix} ]$$

$$and$$

$$[ \begin{matrix}{W}_{2 , r} \\ {W}_{2 , r + N}\end{matrix} ] = {W}_{2 , r , 1} {W}_{2 , r , 2} = [ \begin{matrix}{e}_{{j}_{r}}^{{L}_{r}} & 0 \\ 0 & {e}_{{j}_{r}}^{{L}_{r}}\end{matrix} ] [ \begin{matrix}1 \\ {c}_{r}\end{matrix} ] = [ \begin{matrix}{e}_{{j}_{r}}^{{L}_{r}} \\ {c}_{r} {e}_{{j}_{r}}^{{L}_{r}}\end{matrix} ] , {e}_{{j}_{r}}^{{L}_{r}}$$

is a Lᵣ-element column (selection) vector containing a value of 1 in element jᵣ or (jᵣ mod Lᵣ) and zeros elsewhere, and cᵣ is a coefficient. Note that when Lᵣ=1,

$${W}_{2 , r , 1} = [ \begin{matrix}1 & 0 \\ 0 & 1\end{matrix} ] ,$$

hence eⱼ_{ᵣ}^{L}^{ᵣ} does not need reporting. Hence, eⱼ_{ᵣ}^{L}^{ᵣ} is reported when Lᵣ>1.

For each CSI-RS resource r=1, . . . , N,

$$[ \begin{matrix}{W}_{1 , 2 ( r - 1 ) + 1} & 0 \\ 0 & {W}_{1 , 2 r}\end{matrix} ] = [ \begin{matrix}{B}_{r} & 0 \\ 0 & {B}_{r}\end{matrix} ]$$

$$or$$

$$[ \begin{matrix}{W}_{1 , r} & 0 \\ 0 & {W}_{1 , r + N}\end{matrix} ] = [ \begin{matrix}{B}_{r} & 0 \\ 0 & {B}_{r}\end{matrix} ]$$

is a P_{CSIRS,r}×2Lᵣ SD basis matrix, where the Lᵣ SD basis vectors comprising columns of Bᵣ are determined the same way as in Rel. 15/16 Type II codebooks (cf. 5.2.2.2.3, REF 8), i.e., the SD basis vectors vₘ_{₁}_{^{(r,jr)}}_{,m}_{₂}_{^{(r,jr)}}, i=0, 1, . . . , Lᵣ−1 and r=1, . . . , N are identified by the indices q_{1,r}, q_{2,r}, n_{1,r}, n_{2,r}, can be indicated by PMI components i_{1,1,r}, i_{1,2,r}, and are obtained as in 5.2.2.2.3 of [REF 8].

$${i}_{1 , 1} = [ {i}_{1 , 1 , 1} … {i}_{1 , 1 , N} ]$$

$${i}_{1 , 2} = [ {i}_{1 , 2 , 1} … {i}_{1 , 2 , N} ]$$

$${i}_{1 , 1 , r} = [ {q}_{1 , r} {q}_{2 , r} ]$$

$${q}_{1 , r} ∈ \{ 0 , 1 , … , {O}_{1} - 1 \}$$

$${q}_{2 , r} ∈ \{ 0 , 1 , … , {O}_{2} - 1 \}$$

$${i}_{1 , 2 , r} ∈ \{ 0 , 1 , … , ( \begin{matrix}{N}_{1 , r} {N}_{2 , r} \\ {L}_{r}\end{matrix} ) - 1 \}$$

$$Let$$

$${n}_{1 , r} = [ {n}_{1}^{( r , 0 )} , … , {n}_{1}^{( r , {L}_{r} - 1 )} ]$$

$${n}_{2 , r} = [ {n}_{2}^{( r , 0 )} , … , {n}_{2}^{( r , {L}_{r} - 1 )} ]$$

$${n}_{1}^{( r , i )} ∈ \{ 0 , 1 , … , {N}_{1 , r} - 1 \}$$

$${n}_{2}^{( r , i )} ∈ \{ 0 , 1 , … , {N}_{2 , r} - 1 \}$$

$$and$$

$$C ( x , y ) = \{ \begin{matrix}( \begin{matrix}x \\ y\end{matrix} ) & x \geq y \\ 0 & x < y\end{matrix} .$$

where the values of C (x,y) are given in Table 5.2.2.2.3-1 [REF8].

In one example,

i_{1,1}=[q₁ q₂]

q₁=[q_{1,1} . . . q_{1,N}]

q₂=[q_{2,1} . . . q_{2,N}]

The quantities m₁^{(r,i)},m₂^{(r,i)} are given by

$${m}_{1}^{( r , i )} = {O}_{1} {n}_{1}^{( r , i )} + {q}_{1. r}$$

$${m}_{2}^{( r , i )} = {O}_{2} {n}_{2}^{( r , i )} + {q}_{2. r}$$

and correspond to the DFT beam (vector) indices in the oversampled DFT codebook.

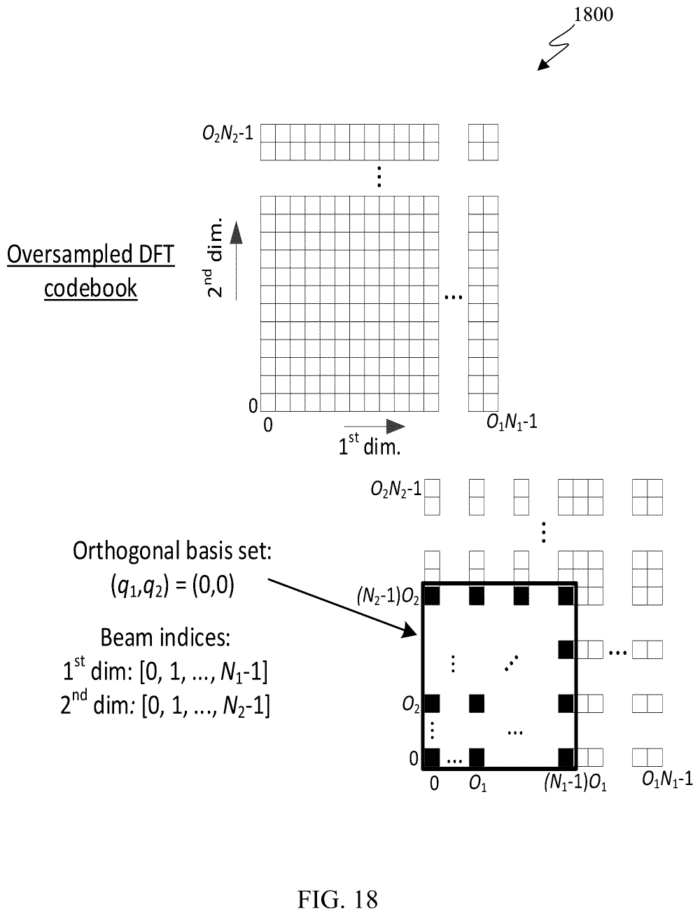

FIG. 18 illustrates an orthogonal basis set for DFT beams 1800 according to embodiments of the present disclosure. The embodiment of the orthogonal basis set for DFT beams 1800 illustrated in FIG. 18 is for illustration only. FIG. 18 does not limit the scope of this disclosure to any particular implementation of the orthogonal basis set for DFT beams 1800.

The L, DFT beams or DFT vectors are selected or identified by the components i_{1,1} and i_{1,2} of the codebook index i₁, where (q₁, q₂) indicates the orthogonal basis set comprising of N₁N₂ DFT beams, an example of which is shown in FIG. 16 for (q₁, q₂)=(0,0) where beams are shown as black squares located in an (N₁, N₂) grid. For brevity, N_{1,r} and N_{2,r} are replaced with N₁ and N₂, respectively.

For the Lᵣ out N₁N₂ beam selection, the N₁N₂ beams in the orthogonal basis set, indicated by (q₁, q₂), are sorted or numbered according to at least one of the following schemes:
Scheme 0: Starting from the leading beam (q₁, q₂), N₁N₂ beams in the orthogonal basis set are sorted or numbered sequentially 0 to N₁N₂−1 first in the 1st dimension and then in the 2nd dimension. For a given beam (n₁⁽ⁱ⁾,n₂⁽ⁱ⁾) in the orthogonal basis set, the sorted beam index is then given by n⁽ⁱ⁾=N₁n₂⁽ⁱ⁾+n₁⁽ⁱ⁾ where the indices i=0, 1, . . . , Lᵣ−1 are assigned such that n (i) increases as i increases.
Scheme 1: Starting from the leading beam (q₁, q₂), N₁N₂ beams are numbered sequentially 0 to N₁N₂−1 first in the 2nd dimension and then in the 1st dimension. For a given beam (n₁⁽ⁱ⁾, n₂⁽ⁱ⁾) in the orthogonal basis set, the sorted beam index is then given by n⁽ⁱ⁾=N₂n₁⁽ⁱ⁾+n₂⁽ⁱ⁾ where the indices i=0, 1, . . . , Lᵣ−1 are assigned such that n⁽ⁱ⁾ increases as i increases.

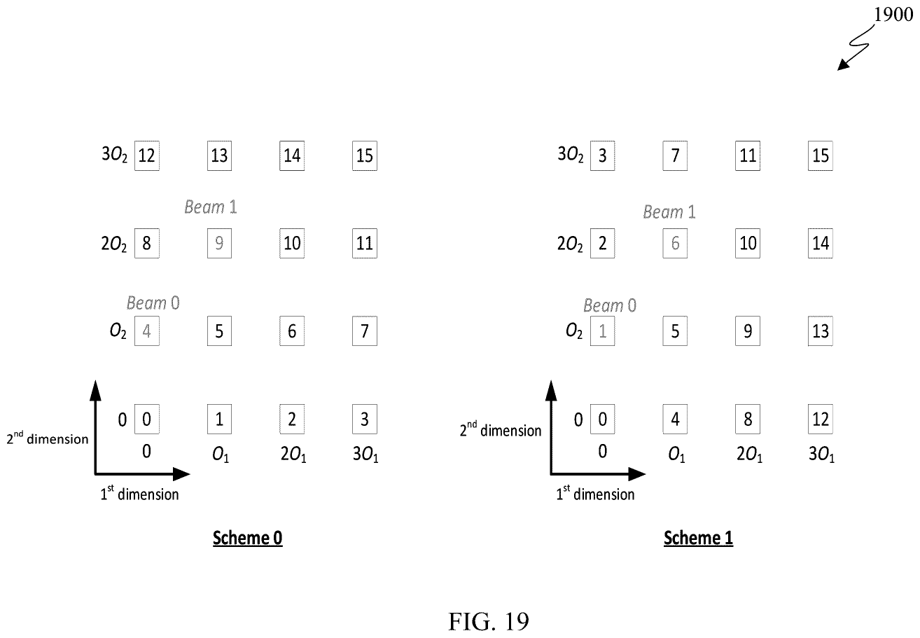

FIG. 19 illustrates an example of a two beam sorting scheme 1900 according to embodiments of the present disclosure. The embodiment of the example two beam sorting scheme 1900 illustrated in FIG. 19 is for illustration only. FIG. 19 does not limit the scope of this disclosure to any particular implementation of the example two beam sorting scheme.

The sorted beam indices n⁽ⁱ⁾∈{0, 1, . . . , N₁N₂−1}. An illustration of the two beam sorting (numbering) schemes are shown in FIG. 19. An example of L=2 out of N₁N₂=16 beam selection is also shown according to the two schemes, where (n₁⁽⁰⁾,n₂⁽⁰⁾)=(0,1) for Beam, 0 and (n₁⁽¹⁾,n₂⁽¹⁾)=(1,2) for Beam 1. According to Scheme 0, Beam 0 and Beam 1 are numbered as n⁽⁰⁾=4 and n⁽¹⁾=9, respectively, and according to Scheme 1, they are numbered as n⁽⁰⁾=1 and n⁽¹⁾=6, respectively.

For a given antenna port layout (N₁, N₂) and oversampling factors (O₁,O₂) for two dimensions, a DFT vector vim can be expressed as follows.

$${v}_{l , m}^{{N}_{1} , {N}_{2}} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

$${u}_{m}^{{N}_{2}} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$

where l∈{0, 1, . . . , O₁N₁−1} and m∈{0, 1, . . . , O₂N₂−1}. Here, (O₁, O₂) can be fixed, e.g., (1,1), (2,2), (2,1), (2,2), (4,1), or (4,4), or configured. (O₁, O₂) can be different across resources. (O₁, O₂) can depend on (N₁, N₂). For example, OᵢNᵢ=v or ≤v where v can be fixed, e.g., 64, 128 or configured.

Let P_{CSIRS,r}=2N_{1,r}N_{2,r} be number of CSI-RS ports associated with CSI-RS resource r. Let K=M₁M₂ be a total number of resources or port groups, where Mᵢ is a number of resources in i-th dimension, and i=1,2. In one example, the UE is configured with one of the following:
In one example, the UE is configured with K or (M₁, M₂), and P_{CSIRS,r}.
In one example, the UE is configured with K or (M₁, M₂), and P_{CSIRS}.
In one example, the UE is configured with P_{CSIRS}, and P_{CSIRS,r}.
In one example, the UE is configured with K or (M₁, M₂), P_{CSIRS,r} and P_{CSIRS}.

In one example, the UE is configured with one of the above parameters from a set of supported combinations of values, which can be all of or a subset of the combinations shown in Table 1.

TABLE 1

| Number of CSI-RS | | Number of resources: M₁ × M₂, |
|---|---|---|
| antenna ports, P_{CSI-RS} | (N₁, N₂) | (M₁, M₂) |
| 4 | (2, 1) | |
| 8 | (2, 2) | |
| | (4, 1) | |
| 12 | (3, 2) | |
| | (6, 1) | |
| 16 | (4, 2) | |
| | (8, 1) | |
| 24 | (4, 3) | |
| | (6, 2) | |
| | (12, 1) | |
| 32 | (4, 4) | |
| | (8, 2) | |
| | (16, 1) | |
| 64 | P_{CSIRS, r} = 2: (1, 1) | (32, 1), (16, 2), (8, 4), (4, 8)(2, 16), (1, 32) |
| | P_{CSIRS, r} = 4: (2, 1) | (16, 1), (8, 2), (4, 4), (2, 8)(1, 16) |
| | P_{CSIRS, r} = 8: | (8, 1), (4, 2), (2, 4), (1, 8) |
| | (2, 2), (4, 1) | |
| | P_{CSIRS, r} = 16: | (4, 1), (2, 2), (1, 4) |
| | (4, 2), (8, 1) | |
| | P_{CSIRS, r} = 32: | (2, 1), (1, 2) |
| | (4, 4), (8, 2), (16, 1) | |
| 96 | P_{CSIRS, r} = 2: (1, 1) | (48, 1), (24, 2), (16, 3), (12, 4), (8, 6), (6, 8), |
| | | (4, 12), (3, 16), (2, 24), (1, 48) |
| | P_{CSIRS, r} = 4: (2, 1) | (24, 1), (12, 2), (8, 3), (6, 4), (4, 6), (3, 8), (2, 12), |
| | | (1, 24) |
| | P_{CSIRS, r} = 8: (2, 2), | (12, 1), (6, 2), (4, 3), (3, 4), (2, 6), (1, 12) |
| | (4, 1) | |
| | P_{CSIRS, r} = 12: | (8, 1), (4, 2), (2, 4), (1, 8) |
| | (3, 2), (6, 1) | |
| | P_{CSIRS, r} = 16: | (6, 1), (3, 2), (2, 3), (1, 6) |
| | (4, 2), (8, 1) | |
| | P_{CSIRS, r} = 24: | (4, 1), (2, 2), (1, 4) |
| | (4, 3), (6, 2), (12, 1) | |
| | P_{CSIRS, r} = 32: | (3, 1), (1, 3) |
| | (4, 4), (8, 2), (16, 1) | |
| 128 | P_{CSIRS, r} = 2: (1, 1) | (64, 1), (32, 2), (16, 4), (8, 8), (4, 16), (2, 32), |
| | | (1, 64) |
| | P_{CSIRS, r} = 4: (2, 1) | (32, 1), (16, 2), (8, 4), (4, 8)(2, 16), (1, 32) |
| | P_{CSIRS, r} = 8: | (16, 1), (8, 2), (4, 4), (2, 8)(1, 16) |
| | (2, 2), (4, 1) | |
| | P_{CSIRS, r} = 16: | (8, 1), (4, 2), (2, 4), (1, 8) |
| | (4, 2), (8, 1) | |
| | P_{CSIRS, r} = 32: | (4, 1), (2, 2), (1, 4) |
| | (4, 4), (8, 2), (16, 1) | |
| | P_{CSIRS, r} = 64: | (2, 1), (1, 2) |
| | (8, 4), (16, 2), (32, 1) | |
| 36 | P_{CSIRS, r} = 2: (1, 1) | (18, 1), (9, 2), (6, 3), (3, 6), (2, 9), (1, 18) |
| | P_{CSIRS, r} = 4: (2, 1) | (9, 1), (3, 3), (1, 9) |
| | P_{CSIRS, r} = 12: | (3, 1), (1, 3) |
| | (6, 1), (3, 2) | |
| 48 | P_{CSIRS, r} = 2: (1, 1) | (24, 1), (12, 2), (8, 3), (3, 8)(2, 12), (1, 24) |
| | P_{CSIRS, r} = 4: (2, 1) | (12, 1), (6, 2), (4, 3), (3, 4), (2, 6)(1, 12) |
| | P_{CSIRS, r} = 8: | (6, 1), (3, 2), (2, 3), (1, 6) |
| | (2, 2), (4, 1) | |
| | P_{CSIRS, r} = 12: | (4, 1), (2, 2), (1, 4) |
| | (4, 2), (8, 1) | |
| | P_{CSIRS, r} = 16: | (3, 1), (1, 3) |
| | (4, 2), (8, 1) | |
| | P_{CSIRS, r} = 24: | (2, 1), (1, 2) |
| | (4, 3), (6, 2) (1 [symbol] | |
| 72 | P_{CSIRS, r} = 2: (1, 1) | (36, 1), (18, 2), (9, 4), (4, 9)(2, 18), (1, 36) |
| | P_{CSIRS, r} = 4: (2, 1) | (18, 1), (9, 2), (2, 9)(1, 18) |
| | P_{CSIRS, r} = 8: | (9, 1), (3, 3), (1, 9) |
| | (2, 2), (4, 1) | |
| | P_{CSIRS, r} = 12: | (6, 1), (3, 2), (2, 3), (1, 6) |
| | (4, 2), (8, 1) | |
| | P_{CSIRS, r} = 16: | (4, 1), (2, 2), (1, 4) |
| | (4, 2), (8, 1) | |
| | P_{CSIRS, r} = 24: | (3, 1), (1, 3) |
| | (4, 3), (6, 2), (12, 1) | |
| | P_{CSIRS, r} = 32: | (2, 1), (1, 2) |
| | (4, 4), (8, 2), (16, 1) | |

[symbol]

indicates data missing or illegible when filed

In one example, the UE is configured with one of the above parameters from a set of supported combinations of values, which can be all of or a subset of the combinations shown in Table 2.

TABLE 2

| Number of CSI-RS | | Number of resources: M₁ × M₂, |
|---|---|---|
| antenna ports, P_{CSI-RS} | (N₁, N₂) | (M₁, M₂) |
| 4 | P_{CSIRS, r} = 2: (1, 1) | (1, 2), (2, 1) |
| | P_{CSIRS, r} = 4: (2, 1) | (1, 1) |
| 8 | P_{CSIRS, r} = 2: (1, 1) | (4, 1), (2, 2), (1, 4) |
| | P_{CSIRS, r} = 4: (2, 1) | (1, 2), (2, 1) |
| | P_{CSIRS, r} = 8: (2, 2), (4, 1) | (1, 1) |
| 12 | P_{CSIRS, r} = 2: (1, 1) | (1, 12), (2, 6), (3, 4), (4, 3), (6, 2), (12, 1) |
| | P_{CSIRS, r} = 4: (2, 1) | (1, 3), (3, 1) |
| | P_{CSIRS, r} = 12: (3, 2), (6, 1) | (1, 1) |
| 16 | P_{CSIRS, r} = 2: (1, 1) | (8, 1), (4, 2), (2, 4), (1, 8) |
| | P_{CSIRS, r} = 4: (2, 1) | (4, 1), (2, 2), (1, 4) |
| | P_{CSIRS, r} = 8: (2, 2), (4, 1) | (2, 1), (1, 2) |
| | P_{CSIRS, r} = 16: (4, 2), (8, 1) | (1, 1) |
| 24 | P_{CSIRS, r} = 2: (1, 1) | (1, 12), (2, 6), (3, 4), (4, 3), (6, 2), (12, 1) |
| | P_{CSIRS, r} = 4: (2, 1) | (1, 6), (2, 3), (3, 2), (6, 1) |
| | P_{CSIRS, r} = 12: (3, 2), (6, 1) | (2, 1), (1, 2) |
| | P_{CSIRS, r} = 24: (6, 2), (4, 3), | (1, 1) |
| | (12, 1) | |
| 32 | P_{CSIRS, r} = 2: (1, 1) | (16, 1), (8, 2), (4, 4), (2, 8)(1, 16) |
| | P_{CSIRS, r} = 4: (2, 1) | (8, 1), (4, 2), (2, 4), (1, 8) |
| | P_{CSIRS, r} = 8: (2, 2), (4, 1) | (4, 1), (2, 2), (1, 4) |
| | P_{CSIRS, r} = 16: (4, 2), (8, 1) | (2, 1), (1, 2) |
| | P_{CSIRS, r} = 32: | (1, 1) |
| | (4, 4), (8, 2), (16, 1) | |
| 64, 96, 128, 36, 48, 72 | Same as in Table 1 | Same as in Table 1 |

In one example,

$${c}_{r} = {e}^{\frac{j 2 π {ϕ}_{r}}{{N}_{PSK}}}$$

where ϕᵣ∈{0, 1, . . . , N_{PSK}−1}, and N_{PSK}=4 (for QPSK), 8 (for 8PSK), or 16 (for 16PSK). In one example, N_{PSK} is fixed, e.g., N_{PSK}=4. In one example, N_{PSK} is configured via higher layer, e.g., from {4,8}.

The selection vector eⱼ_{ᵣ}^{L}^{ᵣ} and coefficient cᵣ for r=1, . . . , N are indentified by the indices jᵣ∈{0, 1, . . . , Lᵣ−1} and ϕᵣ respectively, can be indicated by PMI components i_{2,1,r}, i_{2,2,r}, and are obtained as

i₂=[i_{2,1}, i_{2,2}]

i_{2,1}=[i_{2,1,1} . . . i_{2,1,N}]

i_{2,2}=[i_{2,2,1} . . . i_{2,2,N}]

i_{2,1,r}=jᵣ

i_{2,2,r}=ϕᵣ

In one example,

$${c}_{r} = {p}_{r} {e}^{\frac{j 2 π {ϕ}_{r}}{{N}_{PSK}}}$$

where pᵣ is an amplitude or power level. The selection vector eⱼ_{ᵣ}^{L}^{ᵣ} and coefficient cᵣ for r=1, . . . , N are indentified by the indices jᵣ∈{0, 1, . . . , Lᵣ−1} and (ϕᵣ, kᵣ) respectively, can be indicated by PMI components i_{2,1,r}, i_{2,2,r}, i_{2,3,r}, and are obtained as

i₂=[i_{2,1}, i_{2,2}, i_{2,3}]

The selection vector indicator i_{2,1}=[i_{2,1,1} . . . i_{2,1,N}] where i_{2,1,r}=jᵣ.

The phase coefficient indicators i_{2,2}=[i_{2,2,1} . . . i_{2,2,N}] where i_{2,2,r}=ϕᵣ.

The amplitude coefficient indicators i_{2,3}=[i_{2,3,1} . . . i_{2,3,N}] where i_{2,3,r}=pᵣ.

In one example, the mapping from kᵣ to the amplitude coefficient pᵣ is given one of the examples in Table 3.

TABLE 3
Mapping of elements of i_{2,3,r}: kᵣ to pᵣ

| kᵣ | pᵣ (Ex1) | pᵣ (Ex2) | pᵣ (Ex3) | pᵣ (Ex4) |
|---|---|---|---|---|
| 0 | $\frac{1}{2 \sqrt{2}}$ | 0 | $\frac{1}{8 \sqrt{2}}$ | 0 |
| 1 | $\frac{1}{2}$ | $\frac{1}{2}$ | $\frac{1}{8}$ | $\frac{1}{8}$ |
| 2 | $\frac{1}{\sqrt{2}}$ | $\frac{1}{\sqrt{2}}$ | $\frac{1}{4 \sqrt{2}}$ | $\frac{1}{4 \sqrt{2}}$ |
| 3 | 1 | 1 | $\frac{1}{4}$ | $\frac{1}{4}$ |
| 4 | | | $\frac{1}{2 \sqrt{2}}$ | $\frac{1}{2 \sqrt{2}}$ |
| 5 | | | $\frac{1}{2}$ | $\frac{1}{2}$ |
| 6 | | | $\frac{1}{\sqrt{2}}$ | $\frac{1}{\sqrt{2}}$ |
| 7 | | | 1 | 1 |

In one example, the amplitude/power for one (denoted as r*) of the N CSI-RS resources can be fixed (e.g., p_{r*}=1), hence corresponding k_{r*} is not reported. The index r* can be fixed (e.g., r*=1) or configured (e.g., via higher layer) or reported by the UE (e.g., as part of the CSI parameter or a UCI parameter). When rank>1, the r* can be layer-common, i.e., the same for all layers, or it can be layer-specific, i.e., for each layer l, an index r_{i*} can be fixed or configured, or reported. Or, When rank>1, the r* can be layer-pair-common, i.e., the same for consecutive layer pairs (l, l+1), where l=1, 3, . . . , i.e., a first r₁* common/same for layer pairs (1,2), a second r₂* common/same for layer pairs (3,4), and so on.

For the port numbering scheme 1, the rank-1 (1-layer) precoder is then given by

$${W}_{{i}_{1 , 1} , {i}_{1 , 2} , {i}_{2}}^{( 1 )} = \frac{1}{\sqrt{{P}_{CSIRS}}} [ \begin{matrix}{v}_{{m}_{1}^{( 1 , {j}_{1} )} , {m}_{2}^{( 1 , {j}_{1} )}} \\ {c}_{1} {v}_{{m}_{1}^{( 1 , {j}_{1} )} , {m}_{2}^{( 1 , {j}_{1} )}} \\ {v}_{{m}_{1}^{( 2 , {j}_{2} )} , {m}_{2}^{( 2 , {j}_{2} )}} \\ {c}_{2} {v}_{{m}_{1}^{( 2 , {j}_{2} )} , {m}_{2}^{( 2 , {j}_{2} )}} \\ ⋮ \\ {v}_{{m}_{1}^{( N , {j}_{N} )} , {m}_{2}^{( N , {j}_{N} )}} \\ {c}_{N} {v}_{{m}_{1}^{( N , {j}_{N} )} , {m}_{2}^{( N , {j}_{N} )}}\end{matrix} ] .$$

For the port numbering scheme 2, the rank-1 (1-layer) precoder is then given by

$${W}_{{i}_{1 , 1} , {i}_{1 , 2} , {i}_{2}}^{( 1 )} = \frac{1}{\sqrt{{P}_{CSIRS}}} [ \begin{matrix}{v}_{{m}_{1}^{( 1 , {j}_{1} )} , {m}_{2}^{( 1 , {j}_{1} )}} \\ {v}_{{m}_{1}^{( 2 , {j}_{2} )} , {m}_{2}^{( 2 , {j}_{2} )}} \\ ⋮ \\ {v}_{{m}_{1}^{( N , {j}_{N} )} , {m}_{2}^{( N , {j}_{N} )}} \\ {c}_{1} {v}_{{m}_{1}^{( 1 , {j}_{1} )} , {m}_{2}^{( 1 , {j}_{1} )}} \\ {c}_{2} {v}_{{m}_{1}^{( 2 , {j}_{2} )} , {m}_{2}^{( 2 , {j}_{2} )}} \\ ⋮ \\ {c}_{N} {v}_{{m}_{1}^{( N , {j}_{N} )} , {m}_{2}^{( N , {j}_{N} )}}\end{matrix} ] .$$

In a variation of a previous example, for r=1, . . . , N,

$$[ \begin{matrix}{W}_{2 , 2 ( r - 1 ) + 1} \\ {W}_{2 , 2 r}\end{matrix} ]$$

$$or$$

$$[ \begin{matrix}{W}_{2 , r} \\ {W}_{2 , r + N}\end{matrix} ]$$

is equal to

$${W}_{2 , r , 0} {W}_{2 , r , 1} {W}_{2 , r , 2} = [ \begin{matrix}{d}_{r} & 0 \\ 0 & {d}_{r}\end{matrix} ] [ \begin{matrix}{e}_{{j}_{r}}^{{L}_{r}} & 0 \\ 0 r & {e}_{{j}_{r}}^{{L}_{r}}\end{matrix} ] [ \begin{matrix}1 \\ {c}_{r}\end{matrix} ] = [ \begin{matrix}{d}_{r} {e}_{{j}_{r}}^{{L}_{r}} \\ {c}_{r} {d}_{r} {e}_{{j}_{r}}^{{L}_{r}}\end{matrix} ] ,$$

where dᵣ is an inter-CSIRS-resource coefficient associated with CSI-RS resource r.

In another variation of a previous example, for r=1, . . . , N,

$$[ \begin{matrix}{W}_{2 , 2 ( r - 1 ) + 1} \\ {W}_{2 , 2 r}\end{matrix} ]$$

$$or$$

$$[ \begin{matrix}{W}_{2 , r} \\ {W}_{2 , r + N}\end{matrix} ]$$

is equal to

$${W}_{2 , r , 1} {W}_{2 , r , 2} = [ \begin{matrix}{e}_{{j}_{r}}^{{L}_{r}} & 0 \\ 0 & {e}_{{j}_{r}}^{{L}_{r}}\end{matrix} ] [ \begin{matrix}{c}_{r , 0} \\ {c}_{r , 1}\end{matrix} ] [ \begin{matrix}{c}_{r , 0} {e}_{{j}_{r}}^{{L}_{r}} \\ {c}_{r , 1} {e}_{{j}_{r}}^{{L}_{r}}\end{matrix} ] ,$$

where c_{r,0} and c_{r,1} are coefficients associated with two antenna polarizations (0 and 1) of the CSI-RS resource r.

In another variation of a previous example, for r=1, . . . , N,

$$[ \begin{matrix}{W}_{2 , 2 ( r - 1 ) + 1} \\ {W}_{2 , 2 r}\end{matrix} ]$$

$$or$$

$$[ \begin{matrix}{W}_{2 , r} \\ {W}_{2 , r + N}\end{matrix} ]$$

is equal to

$${W}_{2 , r , 1} {W}_{2 , r , 2} = [ \begin{matrix}{e}_{{j}_{r , 0}}^{{L}_{r}} & 0 \\ 0 & {e}_{{j}_{r , 1}}^{{L}_{r}}\end{matrix} ] [ \begin{matrix}1 \\ {c}_{r}\end{matrix} ] [ \begin{matrix}{e}_{{j}_{r , 0}}^{{L}_{r}} \\ {c}_{r} {e}_{{j}_{r , 1}}^{{L}_{r}}\end{matrix} ] ,$$

where j_{r,0} and j_{r,1} are selected basis vectors associated with two antenna polarizations (0 and 1) of the CSI-RS resource r.

In another variation of a previous example, for r=1, . . . , N,

$$[ \begin{matrix}{W}_{2 , 2 ( r - 1 ) + 1} \\ {W}_{2 , 2 r}\end{matrix} ]$$

$$or$$

$$[ \begin{matrix}{W}_{2 , r} \\ {W}_{2 , r + N}\end{matrix} ]$$

is equal to

$${W}_{2 , r , 0} {W}_{2 , r , 1} {W}_{2 , r , 2} = [ \begin{matrix}{d}_{r} & 0 \\ 0 & {d}_{r}\end{matrix} ] [ \begin{matrix}{e}_{{j}_{r , 0}}^{{L}_{r}} & 0 \\ 0 r & {e}_{{j}_{r , 1}}^{{L}_{r}}\end{matrix} ] [ \begin{matrix}1 \\ {c}_{r}\end{matrix} ] [ \begin{matrix}{d}_{r} {e}_{{j}_{r , 0}}^{{L}_{r}} \\ {c}_{r} {d}_{r} {e}_{{j}_{r , 1}}^{{L}_{r}}\end{matrix} ] .$$

In another variation of a previous example, for r=1, . . . , N,

$$[ \begin{matrix}{W}_{2 , 2 ( r - 1 ) + 1} \\ {W}_{2 , 2 r}\end{matrix} ]$$

$$or$$

$$[ \begin{matrix}{W}_{2 , r} \\ {W}_{2 , r + N}\end{matrix} ]$$

is equal to

$${W}_{2 , r , 1} {W}_{2 , r , 2} = [ \begin{matrix}{d}_{r} & 0 \\ 0 & {d}_{r}\end{matrix} ] [ \begin{matrix}{e}_{{j}_{r , 0}}^{{L}_{r}} & 0 \\ 0 r & {e}_{{j}_{r , 1}}^{{L}_{r}}\end{matrix} ] [ \begin{matrix}{c}_{r , 0} \\ {c}_{r , 1}\end{matrix} ] [ \begin{matrix}{c}_{r , 0} {e}_{{j}_{r , 0}}^{{L}_{r}} \\ {c}_{r , 1} {e}_{{j}_{r , 1}}^{{L}_{r}}\end{matrix} ] .$$

In one example,

$${c}_{r , p} = {e}^{\frac{j 2 π {ϕ}_{r , p}}{{N}_{PSK}}}$$

for r=1, . . . , N and p=0,1, where ϕ_{r,p}∈{0, 1, . . . , N_{PSK}−1}, and N_{PSK}=4 (for QPSK), 8 (for 8PSK), or 16 (for 16PSK). In one example, N_{PSK} is fixed, e.g., N_{PSK}=4. In one example, N_{PSK} is configured via higher layer, e.g., from {4,8}.

In one example,

$${c}_{r , p} = {p}_{r , p} {e}^{\frac{j2 π {ϕ}_{r , p}}{{N}_{PSK}}}$$

for r=1, . . . , N and p=0,1, where p_{r,p} is an amplitude or power level. In one example, the mapping from k_{r,p} to the amplitude coefficient P_{r,p} is according to one of the examples in Table 3.

In one example, the inter-CSIRS-resource coefficient of the 1st CSI-RS resource is fixed, e.g., d₁=1, or configured, or reported by the UE. The inter-CSIRS-resource coefficients of the remaining CSI-RS resources can be reported either independently or relative (differentially) w.r.t. to d₁.

In one example, the coefficient of the 1st polarization of the 1st CSI-RS resource is fixed, e.g., c_{1,0}=1, or configured, or reported by the UE. The coefficients of the remaining polarizations and CSI-RS resources can be reported either independently or relative (differentially) w.r.t. to c_{1,0}.

In general, the selection vector eⱼ_{_{r,p}}^{L}^{ᵣ} and coefficient c_{r,p} for r=1, . . . , N and p=0,1 are identified by the indices j_{r,p}∈{0, 1, . . . , Lᵣ−1} and (ϕ_{r,p}, k_{r,p}) respectively, can be indicated by PMI components i_{2,1,r}, i_{2,2,r}, i_{2,3,r}, and are obtained as

i₂=[i_{2,1},i_{2,2},i_{2,3}]

i_{2,1}=[i_{2,1,1} . . . i_{2,1,N}]

i_{2,2}=[i_{2,2,1} . . . i_{2,2,N}]

i_{2,3}=[i_{2,3,1} . . . i_{2,3,N}]

i_{2,1,r}=[ϕ_{r,0} ϕ_{r,1}]

i_{2,2,r}=[k_{r,0} k_{r,1}]

i_{2,3,r}=[k_{r,0} k_{r,1}]

Or,

i_{2,1}=[i_{2,1,1} . . . i_{2,1,2N}]

i_{2,2}=[i_{2,2,1} . . . i_{2,2,2N}]

i_{2,3}=[i_{2,3,1} . . . i_{2,3,2N}]

[i_{2,1,2(r-1)+1} i_{2,1,2r}]=[j_{r,0} j_{r,1}]

[i_{2,2,2(r-1)+1}+i_{2,2,2r}]=[ϕ_{r,0} ϕ_{r,1}]

[i_{2,3,2(r-1)+1} i_{2,3,2r}]=[k_{r,0} k_{r,1}]

Or,

i_{2,1}=[i_{2,1,1} . . . i_{2,1,N}]

i_{2,2}=[i_{2,2,1} . . . i_{2,2,N}]

i_{2,3}=[i_{2,3,1} . . . i_{2,3,N}]

i_{2,1,r}=[i_{2,1,r,0} i_{2,1,r,1}]

i_{2,2,r}=[i_{2,2,r,0} i_{2,2,r,1}]

i_{2,3,r}=[i_{2,3,r,0} i_{2,3,r,1}]

i_{2,1,r,p}=j_{r,p}

i_{2,2,r,p}=ϕ_{r,p}

i_{2,3,r,p}=k_{r,p}

In general, for the port numbering scheme 1, the rank-1 (1-layer) precoder is then given by

$${W}_{{i}_{1 , 1} , {i}_{1 , 2} , {i}_{2}}^{( 1 )} = \frac{1}{\sqrt{{P}_{CSIRS}}} [ \begin{matrix}{c}_{1 , 0} {v}_{{m}_{1}^{( 1 , {j}_{1 , 0} )} , {m}_{2}^{( 1 , {j}_{1 , 0} )}} \\ {c}_{1 , 1} {v}_{{m}_{1}^{( 1 , {j}_{1 , 1} )} , {m}_{2}^{( 1 , {j}_{1 , 1} )}} \\ {c}_{2 , 0} {v}_{{m}_{1}^{( 2 , {j}_{2 , 0} )} , {m}_{2}^{( 2 , {j}_{2 , 0} )}} \\ {c}_{2 , 1} {v}_{{m}_{1}^{( 2 , {j}_{2 , 1} )} , {m}_{2}^{( 2 , {j}_{2 , 1} )}} \\ ⋮ \\ {c}_{N , 0} {v}_{{m}_{1}^{( N , {j}_{N , 0} )} , {m}_{2}^{( N , {j}_{N , 0} )}} \\ {c}_{N , 1} {v}_{{m}_{1}^{( N , {j}_{N , 1} )} , {m}_{2}^{( N , {j}_{N , 1} )}}\end{matrix} ] .$$

Where depending on the above-mentioned variations, either
j_{r,0} and j_{r,1} can be the same, i.e., j_{r,0}=j_{r,1}=jᵣ, or
j_{r,0} and j_{r,1} can be different, i.e., both j_{r,0}=j_{r,1} and j_{r,0}≠j_{r,1} are possible, or
k_{r,0} and k_{r,1} can be the same, i.e., k_{r,0}=k_{r,1}=kᵣ, or
k_{r,0} and k_{r,1} can be different, i.e., both k_{r,0}=k_{r,1} and k_{r,0}≠k_{r,1} are possible, or
c_{r,0} can be fixed (e.g., 1) and c_{r,1}=cᵣ, or
c_{r,0}=dᵣ and c_{r,1}=dᵣcᵣ.

For the port numbering scheme 2, the rank-1 (1-layer) precoder is then given by

$${W}_{{i}_{1 , 1} , {i}_{1 , 2} , {i}_{2}}^{( 1 )} = \frac{1}{\sqrt{{P}_{CSIRS}}} [ \begin{matrix}{c}_{1 , 0} {v}_{{m}_{1}^{( 1 , {j}_{1 , 0} )} , {m}_{2}^{( 1 , {j}_{1 , 0} )}} \\ {c}_{2 , 0} {v}_{{m}_{1}^{( 2 , {j}_{2 , 0} )} , {m}_{2}^{( 2 , {j}_{2 , 0} )}} \\ ⋮ \\ {c}_{N , 0} {v}_{{m}_{1}^{( N , {j}_{N , 0} )} , {m}_{2}^{( N , {j}_{N , 0} )}} \\ {c}_{1 , 1} {v}_{{m}_{1}^{( 1 , {j}_{1 , 1} )} , {m}_{1}^{( 1 , {j}_{1 , 1} )}} \\ {c}_{2 , 1} {v}_{{m}_{1}^{( 2 , {j}_{2 , 1} )} , {m}_{2}^{( 2 , {j}_{2 , 1} )}} \\ ⋮ \\ {c}_{N , 1} {v}_{{m}_{1}^{( N , {j}_{N , 1} )} , {m}_{2}^{( N , {j}_{N , 1} )}}\end{matrix} ] .$$

In one example, the W₁ has the following structure, i.e., SD basis vectors can be different for two polarizations of a NZP CSI-RS resource.

$${W}_{1} = [ \begin{matrix}{W}_{1 , 1 , 0} & 0 & 0 & 0 & 0 \\ 0 & {W}_{1 , 1 , 1} & 0 & 0 & 0 \\ 0 & 0 & ⋱ & 0 & 0 \\ 0 & 0 & 0 & {W}_{1 , N , 0} & 0 \\ 0 & 0 & 0 & 0 & {W}_{1 , N , 1}\end{matrix} ] ( for numbering scheme 1 )$$

$${W}_{1} = [ \begin{matrix}{W}_{1 , 1 , 0} & 0 & 0 & 0 & 0 & 0 \\ 0 & ⋱ & 0 & 0 & 0 & 0 \\ 0 & 0 & {W}_{1 , N , 0} & 0 & 0 & 0 \\ 0 & 0 & 0 & {W}_{1 , 1 , 1} & 0 & 0 \\ 0 & 0 & 0 & 0 & ⋱ & 0 \\ 0 & 0 & 0 & 0 & 0 & {W}_{1 , N , 1}\end{matrix} ] ( for numbering scheme 2 )$$

where W_{1,r,p}=[b_{r,p,0}, b_{r,p,1}, . . . , b_{r,p,L}_{ᵣ}₋₁] comprises Lᵣ SD basis vectors (as columns) and is associated with CSI-RS resource r∈{1, . . . , N}, polarization p∈{0,1}.

In one example, L, SD basis vectors are the same for all p but can be different for r=1, . . . , N.

$${W}_{1} = [ \begin{matrix}{W}_{1 , 1} & 0 & 0 & 0 & 0 \\ 0 & {W}_{1 , 1} & 0 & 0 & 0 \\ 0 & 0 & ⋱ & 0 & 0 \\ 0 & 0 & 0 & {W}_{1 , N} & 0 \\ 0 & 0 & 0 & 0 & {W}_{1 , N}\end{matrix} ] ( for numbering scheme 1 )$$

$${W}_{1} = [ \begin{matrix}{W}_{1 , 1} & 0 & 0 & 0 & 0 & 0 \\ 0 & ⋱ & 0 & 0 & 0 & 0 \\ 0 & 0 & {W}_{1 , N} & 0 & 0 & 0 \\ 0 & 0 & 0 & {W}_{1 , 1} & 0 & 0 \\ 0 & 0 & 0 & 0 & ⋱ & 0 \\ 0 & 0 & 0 & 0 & 0 & {W}_{1 , N}\end{matrix} ] ( for numbering scheme 2 )$$

In another example, L, SD basis vectors are the same for all r but can be different for p=0,1,

$${W}_{1} = [ \begin{matrix}{W}_{1 , 1} & 0 & 0 & 0 & 0 \\ 0 & {W}_{1 , 2} & 0 & 0 & 0 \\ 0 & 0 & ⋱ & 0 & 0 \\ 0 & 0 & 0 & {W}_{1 , 1} & 0 \\ 0 & 0 & 0 & 0 & {W}_{1 , 2}\end{matrix} ] ( for numbering scheme 1 )$$

$${W}_{1} = [ \begin{matrix}{W}_{1 , 1} & 0 & 0 & 0 & 0 & 0 \\ 0 & ⋱ & 0 & 0 & 0 & 0 \\ 0 & 0 & {W}_{1 , 1} & 0 & 0 & 0 \\ 0 & 0 & 0 & {W}_{1 , 2} & 0 & 0 \\ 0 & 0 & 0 & 0 & ⋱ & 0 \\ 0 & 0 & 0 & 0 & 0 & {W}_{1 , 2}\end{matrix} ] ( for numbering scheme 2 )$$

In another example, L, SD basis vectors are the same for all r and p,

$${W}_{1} = [ \begin{matrix}{W}_{1 , 1} & 0 & 0 & 0 & 0 \\ 0 & {W}_{1 , 1} & 0 & 0 & 0 \\ 0 & 0 & ⋱ & 0 & 0 \\ 0 & 0 & 0 & {W}_{1 , 1} & 0 \\ 0 & 0 & 0 & 0 & {W}_{1 , 1}\end{matrix} ]$$

In one example, Lᵣ=L for all r. In one example, Lᵣ is fixed (e.g., 1 or 4). In one example, Lᵣ is configured (e.g., from {1,2,4}, {2,4,6}, {2,4}, {1,4}, or {1,2,4,6}). In one example, {Lᵣ} is configured via higher layer from a list of supported combinations of {Lᵣ}. An example of the list is shown in Table 4. In one example, the UE is configured with N_{L}≥1 combinations of {Lᵣ} values, and when N_{L}>1, the UE reports selects one of the N_{L} combinations and report the selected combination as part of the CSI report (e.g., via a CSI/UCI parameter in part 1 of a two-part CSI/UCI).

TABLE 4

| N_{TRP} | {Lᵣ} combination |
|---|---|
| 1 | {1} |
| | {2} |
| | {4} |
| | {6} |
| 2 | {1, 1} |
| | {2, 2} |
| | {2, 4}, {4, 2} |
| | {4, 4} |
| 3 | {1, 1, 1,} |
| | {2, 2, 2} |
| | {2, 2, 4}, {2, 4, 2}, {4, 2, 2} |
| | {4, 4, 4} |
| 4 | {1, 1, 1, 1} |
| | {2, 2, 2, 2} |
| | {2, 2, 2, 4} |
| | {2, 2, 4, 4} |
| | {4, 4, 4, 4} |

In one example, Lᵣ depends on the rank value (v). For example, Lᵣ=v or v/2 or └v/2┘ or ┌v/2┐ or v/s or └v/s┘ or ┌v/s┐, where s>1.
In one example, for rank 1-2, Lᵣ=1, for rank 3-4, Lᵣ=2, for rank 5-6, Lᵣ=3, and for rank 7-8, Lᵣ=4.
In one example, for rank 1-4, Lᵣ=2, and rank 5-8, Lᵣ=4.
In one example, for rank 1-8, Lᵣ=a, where a is fixed (e.g., 4) or configured.

In one embodiment for rank value (v)>1, at least one of the following example is used/configured. Let W₁^{(v)} and W₂^{(v)} denote that W₁ and W₂ components for v layers.

In one example, all components of W₁ and W₂, as described above, are determined/reported independently for each layer l=1, . . . , v.
In one example, Lᵣ=1 or
In one example, Lᵣ>1 for all r or
In one example, Lᵣ∈{1, x} where x>1.

In one example, Lᵣ=1 for each r and for each rank v≥1.

In one example, Lᵣ∈{1,x} for rank 1 and Lᵣ=1 for each r and for each rank v>1.

In one example, Lᵣ∈{1,x} for rank 1,2 and Lᵣ=1 for each r and for each rank v>2.

In one example, the rotation factor (q₁, q₂) or {(q_{1,r}, q_{2,r})} are determined/reported common for all layers, and {Lᵣ} SD basis vectors and all components of W₂, as described above, are determined/reported independently for each layer l=1, . . . , v, and W₂ is determined/reported for each layer l=1, . . . , v.

In one example, all components of W₁, as described above, are determined/reported common for all layers, and all components of W₂, as described above, are determined/reported independently for each layer l=1, . . . , v, and W₂ is determined/reported for each layer l=1, . . . , v.

In one example, all components of W₁, as described above, are determined/reported independently for each layer l=1, . . . , v, and one joint W₂ across u layers are determined/reported, where the columns of W₂ correspond to W₂ for u layers.

In one example, the rotation factor (q₁, q₂) or {(q_{1,r}, q_{2,r})} are determined/reported common for all layers, {Lᵣ} SD basis vectors, as described above, are determined/reported independently for each layer l=1, . . . , v, and one joint W2 across v layers are determined/reported, where the columns of W₂ correspond to W₂ for v layers.

In one example, all components of W₁, as described above, are determined/reported common for all layers, and one joint W₂ across v layers are determined/reported, where the columns of W₂ correspond to W₂ for v layers.

In one embodiment, when the number of layers (rank) v=2, the rank-2 (2-layer) precoding matrix is given by

At least one of the following examples is used/configured regarding Uᵣ⁽²⁾, i.e., the portion of the precoding matrix associated with the r-th resource.

$${W}_{{i}_{1 , 1} , {i}_{1 , 2} , {i}_{2}}^{( 2 )} = \frac{1}{\sqrt{2 {P}_{CSIRS}}} [ \begin{matrix}{U}_{1}^{( 2 )} \\ ⋮ \\ {U}_{N}^{( 2 )}\end{matrix} ] .$$

In one example,

$${U}_{r}^{( 2 )} = [ \begin{matrix}{b}_{r} & {b}_{r} \\ {c}_{r} {b}_{r} & - {c}_{r} {b}_{r}\end{matrix} ]$$

where by bᵣ=vₘ_{₁}_{^{(r,jr)}}_{,m}_{₂}_{^{(r,jr)}}. Hence, the indicator (i_{1,1}, i_{1,2}) indicates one set of {bᵣ} and i₂ indicates one set of {cᵣ}.

In one example,

$${U}_{r}^{( 2 )} = [ \begin{matrix}{b}_{r} & {b}_{r} \\ {c}_{r}^{1} {b}_{r} & {c}_{r}^{2} {b}_{r}\end{matrix} ]$$

where bᵣ=vₘ_{₁}_{^{(r,jr)}}_{,m}_{₂}_{^{(r,jr)}} and cᵣ^{l}, l=1,2 is a co-phase for layer l. Hence, the indicator (i_{1,1}, i_{1,2}) indicates one set of {bᵣ} and i₂ indicates two sets of {cᵣ^{l}}, one for each layer.

In one example,

$${U}_{r}^{( 2 )} = [ \begin{matrix}{b}_{r}^{1} & {b}_{r}^{2} \\ {c}_{r} {b}_{r}^{1} & - {c}_{r} {b}_{r}^{2}\end{matrix} ]$$

where by bᵣ^{l}=vₘ_{₁}_{^{(r,jr)}}_{,m}_{₂}_{^{(r,jr)}}, l=1,2 is a DFT vector for layer l. Hence, the indicator (i_{1,1}, i_{1,2}) indicates two sets of {bᵣ^{l}}, one for each layer, and i₂ indicates one set of {cᵣ}.

In one example,

$${U}_{r}^{( 2 )} = [ \begin{matrix}{b}_{r}^{1} & {b}_{r}^{2} \\ {c}_{r}^{1} {b}_{r}^{1} & {c}_{r}^{2} {b}_{r}^{2}\end{matrix} ]$$

where bᵣ^{l} and cᵣ^{l} are as described above. Hence, the indicator (i_{1,1}, i_{1,2}) indicates two sets of {bᵣ^{l}}, one for each layer, and i₂ indicates two sets of {cᵣ^{l}}, one for each layer.

In one example, when the indicator (i_{1,1}, i_{1,2}) indicates two sets of {bᵣ^{l}}, then
In one example, the component (i_{1,1,r}, i_{1,2,r}) indicates (bᵣ¹, bᵣ²) jointly.
In one example, the components i_{1,1,r}=[i_{1,1,r,1}, i_{1,1,r,2}] and i_{1,2,r}=[i_{1,2,r,1}, i_{1,2,r,2}], and (i_{1,1,r,l}, i_{1,2,r,l}) indicates bᵣ^{l}.

In one example, when the indicator i₂ indicates two sets of {cᵣ^{l}}, then
In one example, the component i_{2,r}, indicates (cᵣ¹, cᵣ²) jointly.
In one example, the components i_{2,r}=[i_{2,r,1}, i_{2,r,2}], and i_{2,r,l} indicates cᵣ^{l}.

In general, for the port numbering scheme 1, the rank-2 (2-layer) precoding matrix is given by

$${W}_{{i}_{1 , 1} , {i}_{1 , 2} , {i}_{2}}^{( 2 )} = \frac{1}{\sqrt{2 {P}_{CSIRS}}} [ \begin{matrix}{b}_{1}^{1} & {b}_{1}^{2} \\ {c}_{1}^{1} {b}_{1}^{1} & {c}_{1}^{2} {b}_{1}^{2} \\ ⋮ & ⋮ \\ {b}_{N}^{{1}_{}} & {b}_{N}^{{2}_{}} \\ {c}_{N}^{1} {b}_{N}^{1} & {c}_{N}^{2} {b}_{N}^{2}\end{matrix} ] ( pre - coder structure A 1 ) .$$

Likewise, for the port numbering scheme 2, the rank-2 (2-layer) precoding matrix is given by

$${W}_{{i}_{1 , 1} , {i}_{1 , 2} , {i}_{2}}^{( 2 )} = \frac{1}{\sqrt{2 {P}_{CSIRS}}} [ \begin{matrix}{b}_{1}^{1} & {b}_{1}^{2} \\ {b}_{2}^{1} & {b}_{2}^{2} \\ ⋮ & ⋮ \\ {b}_{N}^{1} & {b}_{N}^{2} \\ {c}_{1}^{1} {b}_{1}^{1} & {c}_{1}^{2} {b}_{1}^{2} \\ {c}_{2}^{1} {b}_{2}^{1} & {c}_{2}^{2} {b}_{2}^{2} \\ ⋮ & ⋮ \\ {c}_{N}^{1} {b}_{N}^{1} & {c}_{N}^{2} {b}_{N}^{2}\end{matrix} ] ( pre - coder structure A 2 ) .$$

In one example, when the DFT vector and/or the corresponding co-phase can be different (hence independently reported) for each antenna polarization and for each resource, for the port numbering scheme 1, the rank-2 (2-layer) precoding matrix is given by

$${W}_{{i}_{1 , 1} , {i}_{1 , 2} , {i}_{2}}^{( 2 )} = \frac{1}{\sqrt{2 {P}_{CSIRS}}} [ \begin{matrix}{c}_{1 , 0}^{1} {b}_{1 , 0}^{1} & {c}_{1 , 0}^{2} {b}_{1 , 0}^{2} \\ {c}_{1 , 1}^{1} {b}_{1 , 1}^{1} & {c}_{1 , 1}^{2} {b}_{1 , 1}^{2} \\ ⋮ & ⋮ \\ {c}_{N , 0}^{1} {b}_{N , 0}^{1} & {c}_{N , 0}^{2} {b}_{N , 0}^{2} \\ {c}_{N , 1}^{1} {b}_{N , 1}^{1} & {c}_{N , 1}^{2} {b}_{N , 1}^{2}\end{matrix} ] ( pre - coder structure A 3 )$$

where

$${b}_{r , p}^{l} = {v}_{{m}_{1}^{( r , {j}_{r , p} )} , {m}_{2}^{( r , {j}_{r , p} )} , l} ,$$

l is a DFT vector, and c_{r,p}^{l}, l=1,2 is a co-phase for layer l and antenna group (polarization) p, respectively.

Likewise, for the port numbering scheme 2, the rank-2 (2-layer) precoding matrix is given by

$${W}_{{i}_{1 , 1} , {i}_{1 , 2} , {i}_{2}}^{( 2 )} = \frac{1}{\sqrt{2 {P}_{CSIRS}}} [ \begin{matrix}{c}_{1 , 0}^{1} {b}_{1 , 0}^{1} & {c}_{1 , 0}^{2} {b}_{1 , 0}^{2} \\ ⋮ & ⋮ \\ {c}_{N , 1}^{1} {b}_{N , 1}^{1} & {c}_{N , 1}^{2} {b}_{N , 1}^{2} \\ {c}_{1 , 0}^{1} {b}_{1 , 0}^{1} & {c}_{1 , 0}^{2} {b}_{1 , 0}^{2} \\ ⋮ & ⋮ \\ {c}_{N , 1}^{1} {b}_{N , 1}^{1} & {c}_{N , 1}^{2} {b}_{N , 1}^{2}\end{matrix} ] ( pre - coder structure A 4 ) .$$

In one example,

$${c}_{r , p}^{l} = {e}^{\frac{j 2 π {ϕ}_{r , p}^{l}}{{N}_{PSK}}}$$

where ϕ_{r,p}^{l}∈{0, 1, . . . , N_{PSK}−1}, and N_{PSK}=4 (for QPSK), 8 (for 8PSK), or 16 (for 16PSK). In one example, N_{PSK} is fixed, e.g., N_{PSK}=4. In one example, N_{PSK} is configured via higher layer, e.g., from {4,8}.

In one example,

$${c}_{r , p}^{l} = {p}_{r , p}^{l} {e}^{\frac{j 2 {πϕ}_{r , p}^{l}}{{N}_{PSK}}}$$

where p_{r,p}^{l} is an amplitude or power level. The details of the amplitude and power level are as described above.
In one example, the amplitude/power level is common (the same, one value) across layers, i.e., p_{r,p}^{l}=p_{r,p} is reported for each r and p.
In one example, the amplitude/power level is independent (can be different) across layers, i.e., p_{r,p}^{l} for each layer is reported for each r and p and l.
In one example, the amplitude/power level is common (the same, one value) across layers and polarization, i.e., p_{r,p}^{l}=pᵣ is reported for each r.
In one example, the amplitude/power level is independent (can be different) across layers but common (the same) across polarizations, i.e., P_{r,p}^{l}=pᵣ^{l} for each layer is reported for each r and l.

### Rank>2

Let us denote

$${P}_{{A}_{1}}^{l} = [ \begin{matrix}{b}_{1}^{l} \\ {c}_{1}^{l} {b}_{1}^{l} \\ ⋮ \\ {b}_{N}^{l} \\ {c}_{N}^{l} {b}_{N}^{l}\end{matrix} ] , {P}_{{A}_{2}}^{l} = [ \begin{matrix}{b}_{1}^{l} \\ {b}_{2}^{l} \\ ⋮ \\ {b}_{N}^{l} \\ {c}_{1}^{l} {b}_{1}^{l} \\ {c}_{2}^{l} {b}_{2}^{l} \\ ⋮ \\ {c}_{N}^{l} {b}_{N}^{l}\end{matrix} ] , {P}_{{A}_{3}}^{l} = [ \begin{matrix}{c}_{1 , 0}^{l} {b}_{1 , 0}^{l} \\ {c}_{1 , 1}^{l} {b}_{1 , 1}^{l} \\ ⋮ \\ {c}_{N , 0}^{l} {b}_{N , 0}^{l} \\ {c}_{N , 1}^{l} {b}_{N , 1}^{l}\end{matrix} ] , {P}_{{A}_{4}}^{l} = [ \begin{matrix}{c}_{1 , 0}^{l} {b}_{1 , 0}^{l} \\ ⋮ \\ {c}_{N , 1}^{l} {b}_{N , 1}^{l} \\ {c}_{1 , 0}^{l} {b}_{1 , 0}^{l} \\ ⋮ \\ {c}_{N , 1}^{l} {b}_{N , 1}^{l}\end{matrix} ] .$$

In one embodiment, when the number of layers (rank) v=3,4, the precoding matrix is given by one of the following examples.

In one example, for the port numbering scheme 1, the precoding matrix is given by

$${W}_{{i}_{1 , 1} , {i}_{1 , 2} , {i}_{2}}^{( 3 )} = \frac{1}{\sqrt{3 {P}_{CSIRS}}} [ \begin{matrix}{P}_{{A}_{1}}^{1} & {P}_{{A}_{1}}^{2} & {P}_{{A}_{1}}^{3}\end{matrix} ] ( pre - coder structure A 1 ) . \\ {W}_{{i}_{1 , 1} , {i}_{1 , 2} , {i}_{2}}^{( 4 )} = \frac{1}{\sqrt{4 {P}_{CSIRS}}} [ \begin{matrix}{P}_{{A}_{1}}^{1} & {P}_{{A}_{1}}^{2} & {P}_{{A}_{1}}^{3} & {P}_{{A}_{1}}^{4}\end{matrix} ] ( pre - coder structure A 1 ) .$$

In one example, for the port numbering scheme 2, the precoding matrix is given by

$${W}_{{i}_{1 , 1} , {i}_{1 , 2} , {i}_{2}}^{( 3 )} = \frac{1}{\sqrt{3 {P}_{CSIRS}}} [ \begin{matrix}{P}_{{A}_{2}}^{1} & {P}_{{A}_{2}}^{2} & {P}_{{A}_{2}}^{3}\end{matrix} ] ( pre - coder structure A 2 ) . \\ {W}_{{i}_{1 , 1} , {i}_{1 , 2} , {i}_{2}}^{( 4 )} = \frac{1}{\sqrt{4 {P}_{CSIRS}}} [ \begin{matrix}{P}_{{A}_{2}}^{1} & {P}_{{A}_{2}}^{2} & {P}_{{A}_{2}}^{3} & {P}_{{A}_{2}}^{4}\end{matrix} ] ( pre - coder structure A 2 ) .$$

In one example, for the port numbering scheme 1, the precoding matrix is given by

$${W}_{{i}_{1 , 1} , {i}_{1 , 2} , {i}_{2}}^{( 3 )} = \frac{1}{\sqrt{3 {P}_{CSIRS}}} [ \begin{matrix}{P}_{{A}_{3}}^{1} & {P}_{{A}_{3}}^{2} & {P}_{{A}_{3}}^{3}\end{matrix} ] ( pre - coder structure A 3 ) . \\ {W}_{{i}_{1 , 1} , {i}_{1 , 2} , {i}_{2}}^{( 4 )} = \frac{1}{\sqrt{4 {P}_{CSIRS}}} [ \begin{matrix}{P}_{{A}_{3}}^{1} & {P}_{{A}_{3}}^{2} & {P}_{{A}_{3}}^{3} & {P}_{{A}_{3}}^{4}\end{matrix} ] ( pre - coder structure A 3 ) .$$

In one example, for the port numbering scheme 2, the precoding matrix is given by

$${W}_{{i}_{1 , 1} , {i}_{1 , 2} , {i}_{2}}^{( 3 )} = \frac{1}{\sqrt{3 {P}_{CSIRS}}} [ \begin{matrix}{P}_{{A}_{4}}^{1} & {P}_{{A}_{4}}^{2} & {P}_{{A}_{4}}^{3}\end{matrix} ] ( pre - coder structure A 4 ) . \\ {W}_{{i}_{1 , 1} , {i}_{1 , 2} , {i}_{2}}^{( 4 )} = \frac{1}{\sqrt{4 {P}_{CSIRS}}} [ \begin{matrix}{P}_{{A}_{4}}^{1} & {P}_{{A}_{4}}^{2} & {P}_{{A}_{4}}^{3} & {P}_{{A}_{4}}^{4}\end{matrix} ] ( pre - coder structure A 4 ) .$$

The rank 3,4 precoding matrix includes components: (i) up to four sets of {bᵣ^{l}} and (ii) up to four sets of {cᵣ^{l}}.
In one example, the indicator (i_{1,1}, i_{1,2}) indicates one set of {bᵣ^{l}, =bᵣ} and i₂ indicates one set of {cᵣ^{l}=cᵣ}, both are common (the same) for all layers.
In one example, the indicator (i_{1,1}, i_{1,2}) indicates one set of {bᵣ^{l}=bᵣ} that is common (the same) for all layers, and i₂ indicates two sets of {cᵣ¹=cᵣ²} and {cᵣ³=cᵣ⁴}, that are common (the same) for layer pairs (1,2) and (3,4), respectively.
In one example, the indicator (i_{1,1}, i_{1,2}) indicates one set of {bᵣ^{l}=bᵣ} that is common (the same) for all layers, and i₂ indicates v=3,4 sets of {cᵣ^{l}}, one for each layer.
In one example, the indicator (i_{1,1}, i_{1,2}) indicates two sets of {bᵣ²=bᵣ²} and {bᵣ³=bᵣ⁴} that are common (the same) for layer pairs (1,2) and (3,4), respectively, and i₂ indicates one set of {cᵣ^{l}=cᵣ}, that is common (the same) for all layers.
In one example, the indicator (i_{1,1}, i_{1,2}) indicates two sets of {bᵣ¹=bᵣ²} and {bᵣ³=bᵣ⁴} that are common (the same) for layer pairs (1,2) and (3,4), respectively, and i₂ indicates two sets of {cᵣ¹=cᵣ²} and {cᵣ³=cᵣ⁴}, that are common (the same) for layer pairs (1,2) and (3,4), respectively.
In one example, the indicator (i_{1,1}, i_{1,2}) indicates two sets of {bᵣ¹=bᵣ²} and {bᵣ³=bᵣ⁴} that are common (the same) for layer pairs (1,2) and (3,4), respectively, and i₂ indicates v=3,4 sets of {cᵣ^{l}}, one for each layer.
In one example, the indicator (i_{1,1}, i_{1,2}) indicates v=3,4 sets of {bᵣ^{l}}, one for each layer, and i₂ indicates one set of {cᵣ^{l}=cᵣ}, that is common (the same) for all layers.
In one example, the indicator (i_{1,1}, i_{1,2}) indicates v=3,4 sets of {bᵣ^{l}}, one for each layer, and i₂ indicates two sets of {cᵣ¹=cᵣ²} and {cᵣ³=cᵣ⁴}, that are common (the same) for layer pairs (1,2) and (3,4), respectively.
In one example, the indicator (i_{1,1}, i_{1,2}) indicates v=3,4 sets of {bᵣ^{l}}, one for each layer, and i₂ indicates v=3,4 sets of {cᵣ^{l}}, one for each layer.

In one embodiment, when the number of layers (rank) v=5,6, the precoding matrix is given by one of the following examples.

In one example, for the port numbering scheme 1, the precoding matrix is given by

$${W}_{{i}_{1 , 1} , {i}_{1 , 2} , {i}_{2}}^{( 5 )} = \frac{1}{\sqrt{5 {P}_{CSIRS}}} [ \begin{matrix}{P}_{{A}_{1}}^{1} & {P}_{{A}_{1}}^{2} & {P}_{{A}_{1}}^{3} & {P}_{{A}_{1}}^{4} & {P}_{{A}_{1}}^{5}\end{matrix} ] ( pre - coder structure A 1 ) . \\ {W}_{{i}_{1 , 1} , {i}_{1 , 2} , {i}_{2}}^{( 6 )} = \frac{1}{\sqrt{6 {P}_{CSIRS}}} [ \begin{matrix}{P}_{{A}_{1}}^{1} & {P}_{{A}_{1}}^{2} & {P}_{{A}_{1}}^{3} & {P}_{{A}_{1}}^{4} & {P}_{{A}_{1}}^{5} & {P}_{{A}_{1}}^{6}\end{matrix} ] ( pre - coder structure A 1 ) .$$

In one example, for the port numbering scheme 2, the precoding matrix is given by

$${W}_{{i}_{1 , 1} , {i}_{1 , 2} , {i}_{2}}^{( 5 )} = \frac{1}{\sqrt{5 {P}_{CSIRS}}} [ \begin{matrix}{P}_{{A}_{2}}^{1} & {P}_{{A}_{2}}^{2} & {P}_{{A}_{2}}^{3} & {P}_{{A}_{2}}^{4} & {P}_{{A}_{2}}^{5}\end{matrix} ] ( pre - coder structure A 2 ) . \\ {W}_{{i}_{1 , 1} , {i}_{1 , 2} , {i}_{2}}^{( 6 )} = \frac{1}{\sqrt{6 {P}_{CSIRS}}} [ \begin{matrix}{P}_{{A}_{2}}^{1} & {P}_{{A}_{2}}^{2} & {P}_{{A}_{2}}^{3} & {P}_{{A}_{2}}^{4} & {P}_{{A}_{2}}^{5} & {P}_{{A}_{2}}^{5}\end{matrix} ] ( pre - coder structure A 2 ) .$$

In one example, for the port numbering scheme 1, the precoding matrix is given by

$${W}_{{i}_{1 , 1} , {i}_{1 , 2} , {i}_{2}}^{( 5 )} = \frac{1}{\sqrt{5 {P}_{CSIRS}}} [ \begin{matrix}{P}_{{A}_{3}}^{1} & {P}_{{A}_{3}}^{2} & {P}_{{A}_{3}}^{3} & {P}_{{A}_{3}}^{4} & {P}_{{A}_{3}}^{5}\end{matrix} ] ( pre - coder structure A 3 ) . \\ {W}_{{i}_{1 , 1} , {i}_{1 , 2} , {i}_{2}}^{( 6 )} = \frac{1}{\sqrt{6 {P}_{CSIRS}}} [ \begin{matrix}{P}_{{A}_{3}}^{1} & {P}_{{A}_{3}}^{2} & {P}_{{A}_{3}}^{3} & {P}_{{A}_{3}}^{4} & {P}_{{A}_{3}}^{5} & {P}_{{A}_{3}}^{6}\end{matrix} ] ( pre - coder structure A 3 ) .$$

In one example, for the port numbering scheme 2, the precoding matrix is given by

$${W}_{{i}_{1 , 1} , {i}_{1 , 2} , {i}_{2}}^{( 5 )} = \frac{1}{\sqrt{5 {P}_{CSIRS}}} [ \begin{matrix}{P}_{{A}_{4}}^{1} & {P}_{{A}_{4}}^{2} & {P}_{{A}_{4}}^{3} & {P}_{{A}_{4}}^{4} & {P}_{{A}_{4}}^{5}\end{matrix} ] ( pre - coder structure A 4 ) . \\ {W}_{{i}_{1 , 1} , {i}_{1 , 2} , {i}_{2}}^{( 6 )} = \frac{1}{\sqrt{6 {P}_{CSIRS}}} [ \begin{matrix}{P}_{{A}_{4}}^{1} & {P}_{{A}_{4}}^{2} & {P}_{{A}_{4}}^{3} & {P}_{{A}_{4}}^{4} & {P}_{{A}_{4}}^{5} & {P}_{{A}_{4}}^{6}\end{matrix} ] ( pre - coder structure A 4 ) .$$

The corresponding rank 5,6 precoding matrix includes components: (i) up to six sets of {bᵣ^{l}} and (ii) up to six sets of {cᵣ^{l}}.
In one example, the indicator (i_{1,1}, i_{1,2}) indicates one set of {bᵣ^{l}=bᵣ} and i₂ indicates one set of {cᵣ^{l}=cᵣ}, both are common (the same) for all layers.
In one example, the indicator (i_{1,1}, i_{1,2}) indicates one set of {bᵣ^{l}=bᵣ} that is common (the same) for all layers, and i₂ indicates three sets of {cᵣ¹=cᵣ²}, {cᵣ³=cᵣ⁴} and {cᵣ⁵=cᵣ⁶}, that are common (the same) for layer pairs (1,2), (3,4) and (5,6), respectively.
In one example, the indicator (i_{1,1}, i_{1,2}) indicates one set of {bᵣ^{l}=bᵣ} that is common (the same) for all layers, and i₂ indicates v=5,6 sets of {cᵣ^{l}}, one for each layer.
In one example, the indicator (i_{1,1}, i_{1,2}) indicates three sets of {bᵣ¹=bᵣ²}, {bᵣ³=bᵣ⁴}, and {bᵣ⁵=bᵣ⁶} that are common (the same) for layer pairs (1,2), (3,4), and (5,6), respectively, and i₂ indicates one set of {cᵣ^{l}=cᵣ}, that is common (the same) for all layers.
In one example, the indicator (i_{1,1}, i_{1,2}) indicates three sets of {bᵣ¹=bᵣ²}, {bᵣ³=bᵣ⁴}, and {bᵣ⁵=bᵣ⁶} that are common (the same) for layer pairs (1,2), (3,4), and (5,6), respectively, and i₂ indicates three sets of {cᵣ¹=cᵣ²}, {cᵣ³=cᵣ⁴} and {cᵣ⁵=cᵣ⁶}, that are common (the same) for layer pairs (1,2), (3,4) and (5,6), respectively.
In one example, the indicator (i_{1,1}, i_{1,2}) indicates three sets of {bᵣ¹=bᵣ²}, {bᵣ³=bᵣ⁴}, and {bᵣ⁵=bᵣ⁶} that are common (the same) for layer pairs (1,2), (3,4), and (5,6), respectively, and i₂ indicates v=5,6 sets of {cᵣ^{l}}, one for each layer.
In one example, the indicator (i_{1,1}, i_{1,2}) indicates v=5,6 sets of {bᵣ^{l}}, one for each layer, and i₂ indicates one set of {cᵣ^{l}=cᵣ}, that is common (the same) for all layers.
In one example, the indicator (i_{1,1}, i_{1,2}) indicates v=5,6 sets of {bᵣ^{l}}, one for each layer, and i₂ indicates three sets of {cᵣ¹=cᵣ²}, {cᵣ³=cᵣ⁴} and {cᵣ⁵=cᵣ⁶}, that are common (the same) for layer pairs (1,2), (3,4) and (5,6), respectively.
In one example, the indicator (i_{1,1}, i_{1,2}) indicates v=5,6 sets of {bᵣ^{l}}, one for each layer, and i₂ indicates v=5,6 sets of {cᵣ^{l}}, one for each layer.

In one embodiment, when the number of layers (rank) v=5-8, the rank 5-6 precoding matrix is as described above, and the rank 7-8 precoding matrix is given by one of the following examples.

In one example, for the port numbering scheme 1, the precoding matrix is given by

$${W}_{{i}_{1 , 1} , {i}_{1 , 2} , {i}_{2}}^{( 7 )} = \frac{1}{\sqrt{7 {P}_{CSIRS}}} [ {P}_{{A}_{1}}^{1} {P}_{{A}_{1}}^{2} {P}_{{A}_{1}}^{3} {P}_{{A}_{1}}^{4} {P}_{{A}_{1}}^{5} {P}_{{A}_{1}}^{6} {P}_{{A}_{1}}^{7} ] ( pre - coder structure A 1 ) .$$

$${W}_{{i}_{1 , 1} , {i}_{1 , 2} , {i}_{2}}^{( 8 )} = \frac{1}{\sqrt{8 {P}_{CSIRS}}} [ {P}_{{A}_{1}}^{1} {P}_{{A}_{1}}^{2} {P}_{{A}_{1}}^{3} {P}_{{A}_{1}}^{4} {P}_{{A}_{1}}^{5} {P}_{{A}_{1}}^{6} {P}_{{A}_{1}}^{7} {P}_{{A}_{1}}^{8} ] ( pre - coder structure A 1 ) .$$

In one example, for the port numbering scheme 2, the precoding matrix is given by

$${W}_{{i}_{1 , 1} , {i}_{1 , 2} , {i}_{2}}^{( 7 )} = \frac{1}{\sqrt{7 {P}_{CSIRS}}} [ {P}_{{A}_{2}}^{1} {P}_{{A}_{2}}^{2} {P}_{{A}_{2}}^{3} {P}_{{A}_{2}}^{4} {P}_{{A}_{2}}^{5} {P}_{{A}_{2}}^{6} {P}_{{A}_{2}}^{7} ] ( pre - coder structure A 2 ) .$$

$${W}_{{i}_{1 , 1} , {i}_{1 , 2} , {i}_{2}}^{( 8 )} = \frac{1}{\sqrt{8 {P}_{CSIRS}}} [ {P}_{{A}_{2}}^{1} {P}_{{A}_{2}}^{2} {P}_{{A}_{2}}^{3} {P}_{{A}_{2}}^{4} {P}_{{A}_{2}}^{5} {P}_{{A}_{2}}^{6} {P}_{{A}_{2}}^{7} {P}_{{A}_{2}}^{8} ] ( pre - coder structure A 2 ) .$$

In one example, for the port numbering scheme 1, the precoding matrix is given by

$${W}_{{i}_{1 , 1} , {i}_{1 , 2} , {i}_{2}}^{( 7 )} = \frac{1}{\sqrt{7 {P}_{CSIRS}}} [ {P}_{{A}_{3}}^{1} {P}_{{A}_{3}}^{2} {P}_{{A}_{3}}^{3} {P}_{{A}_{3}}^{4} {P}_{{A}_{3}}^{5} {P}_{{A}_{3}}^{6} {P}_{{A}_{3}}^{7} ] ( pre - coder structure A 3 ) .$$

$${W}_{{i}_{1 , 1} , {i}_{1 , 2} , {i}_{2}}^{( 8 )} = \frac{1}{\sqrt{8 {P}_{CSIRS}}} [ {P}_{{A}_{3}}^{1} {P}_{{A}_{3}}^{2} {P}_{{A}_{3}}^{3} {P}_{{A}_{3}}^{4} {P}_{{A}_{3}}^{5} {P}_{{A}_{3}}^{6} {P}_{{A}_{3}}^{7} {P}_{{A}_{3}}^{8} ] ( pre - coder structure A 3 ) .$$

In one example, for the port numbering scheme 2, the precoding matrix is given by

$${W}_{{i}_{1 , 1} , {i}_{1 , 2} , {i}_{2}}^{( 7 )} = \frac{1}{\sqrt{7 {P}_{CSIRS}}} [ {P}_{{A}_{4}}^{1} {P}_{{A}_{4}}^{2} {P}_{{A}_{4}}^{3} {P}_{{A}_{4}}^{4} {P}_{{A}_{4}}^{5} {P}_{{A}_{4}}^{6} {P}_{{A}_{4}}^{7} ] . \qquad ( pre - coder structure A4 )$$

$${W}_{{i}_{1 , 1} , {i}_{1 , 2} , {i}_{2}}^{( 8 )} = \qquad ( pre - coder structure A4 )$$

$$\frac{1}{\sqrt{8 {P}_{CSIRS}}} [ \text{} {P}_{{A}_{4}}^{1} {P}_{{A}_{4}}^{2} {P}_{{A}_{4}}^{3} {P}_{{A}_{4}}^{4} {P}_{{A}_{4}}^{5} {P}_{{A}_{4}}^{6} {P}_{{A}_{4}}^{7} {P}_{{A}_{4}}^{8} ] .$$

The corresponding rank 5-8 precoding matrix includes components: (i) up to eight sets of {bᵣ^{l}} and (ii) up to eight sets of {cᵣ^{l}}.
In one example, the indicator (i_{1,1}, i_{1,2}) indicates one set of {bᵣ^{l}=bᵣ} and i₂ indicates one set of {cᵣ^{l}=cᵣ}, both are common (the same) for all layers.
In one example, the indicator (i_{1,1}, i_{1,2}) indicates one set of {bᵣ^{l}=bᵣ} that is common (the same) for all layers, and i₂ indicates two sets of {cᵣ¹=cᵣ²=cᵣ³=cᵣ⁴} and {cᵣ⁵=cᵣ⁶=cᵣ⁷=cᵣ⁸} that are common (the same) for layer quadruples (1,2,3,4) and (5,6,7,8), respectively.
In one example, the indicator (i_{1,1}, i_{1,2}) indicates one set of {bᵣ^{l}=bᵣ} that is common (the same) for all layers, and i₂ indicates up to four sets of {cᵣ¹=cᵣ²}, {cᵣ³=cᵣ⁴}, {cᵣ⁵=cᵣ⁶}, and {cᵣ⁷=cᵣ⁸} that are common (the same) for layer pairs (1,2), (3,4), (5,6), and (7,8), respectively.
In one example, the indicator (i_{1,1}, i_{1,2}) indicates one set of {bᵣ^{l}=bᵣ} that is common (the same) for all layers, and i₂ indicates v=5-8 sets of {cᵣ^{l}}, one for each layer.
In one example, the indicator (i_{1,1}, i_{1,2}) indicates two sets of {bᵣ¹=bᵣ²=bᵣ³=bᵣ⁴} and {bᵣ⁵=bᵣ⁶=bᵣ⁷=bᵣ⁸} that are common (the same) for layer quadruples (1,2,3,4) and (5,6,7,8), respectively, and i₂ indicates one set of {cᵣ^{l}=cᵣ}, both are common (the same) for all layers.
In one example, the indicator (i_{1,1}, i_{1,2}) indicates two sets of {bᵣ¹=bᵣ²=bᵣ³=bᵣ⁴} and {bᵣ⁵=bᵣ⁶=bᵣ⁷=bᵣ⁸} that are common (the same) for layer quadruples (1,2,3,4) and (5,6,7,8), respectively, and i₂ indicates two sets of {cᵣ¹=cᵣ²=cᵣ³=cᵣ⁴} and {cᵣ⁵=cᵣ⁶=cᵣ⁷=cᵣ⁸} that are common (the same) for layer quadruples (1,2,3,4) and (5,6,7,8), respectively.
In one example, the indicator (i_{1,1}, i_{1,2}) indicates two sets of {bᵣ¹=bᵣ²=bᵣ³=bᵣ⁴} and {bᵣ⁵=bᵣ⁶=bᵣ⁷=bᵣ⁸} that are common (the same) for layer quadruples (1,2,3,4) and (5,6,7,8), respectively, and i₂ indicates up to four sets of {cᵣ¹=cᵣ²}, {cᵣ³=cᵣ⁴}, {cᵣ⁵=cᵣ⁶}, and {cᵣ⁷=cᵣ⁸} that are common (the same) for layer pairs (1,2), (3,4), (5,6), and (7,8), respectively.
In one example, the indicator (i_{1,1}, i_{1,2}) indicates two sets of {bᵣ¹=bᵣ²=bᵣ³=bᵣ⁴} and {bᵣ⁵=bᵣ⁶=bᵣ⁷=bᵣ⁸} that are common (the same) for layer quadruples (1,2,3,4) and (5,6,7,8), respectively, and i₂ indicates v=5-8 sets of {cᵣ^{l}}, one for each layer.
In one example, the indicator (i_{1,1}, i_{1,2}) indicates up to four sets of {bᵣ¹=bᵣ²}, {bᵣ³=bᵣ⁴}, {bᵣ⁵=bᵣ⁶}, and {bᵣ⁷=bᵣ⁸} that are common (the same) for layer pairs (1,2), (3,4), (5,6) and (7,8), respectively, and i₂ indicates one set of {cᵣ^{l}=cᵣ}, that is common (the same) for all layers.
In one example, the indicator (i_{1,1}, i_{1,2}) indicates up to four sets of {bᵣ¹=bᵣ²}, {bᵣ³=bᵣ⁴}, {bᵣ⁵=bᵣ⁶}, and {bᵣ⁷=bᵣ⁸} that are common (the same) for layer pairs (1,2), (3,4), (5,6) and (7,8), respectively, and i₂ indicates two sets of {cᵣ¹=cᵣ²=cᵣ³=cᵣ⁴} and {cᵣ⁵=cᵣ⁶=cᵣ⁷=cᵣ⁸} that are common (the same) for layer quadruples (1,2,3,4) and (5,6,7,8), respectively.
In one example, the indicator (i_{1,1}, i_{1,2}) indicates up to four sets of {bᵣ¹=bᵣ²}, {bᵣ³=bᵣ⁴}, {bᵣ⁵=bᵣ⁶}, and {bᵣ⁷=bᵣ⁸} that are common (the same) for layer pairs (1,2), (3,4), (5,6) and (7,8), respectively, and i₂ indicates up to four sets of {cᵣ¹=cᵣ²}, {cᵣ³=cᵣ⁴}, {cᵣ⁵=_{c}⁶}, and {cᵣ⁷=cᵣ⁸} that are common (the same) for layer pairs (1,2), (3,4), (5,6), and (7,8), respectively.
In one example, the indicator (i_{1,1}, i_{1,2}) indicates up to four sets of {bᵣ¹=bᵣ²}, {bᵣ³=bᵣ⁴}, {bᵣ⁵=bᵣ⁶}, and {bᵣ⁷=bᵣ⁸} that are common (the same) for layer pairs (1,2), (3,4), (5,6) and (7,8), respectively, and i₂ indicates v=5-8 sets of {cᵣ^{l}}, one for each layer.
In one example, the indicator (i_{1,1}, i_{1,2}) indicates v=5-8 sets of {bᵣ^{l}}, one for each layer, and i₂ indicates one set of {cᵣ^{l}=cᵣ}, that is common (the same) for all layers.
In one example, the indicator (i_{1,1}, i_{1,2}) v, and i₂ indicates two sets of {cᵣ¹=cᵣ²=cᵣ³=cᵣ⁴} and {cᵣ⁵=cᵣ⁶=cᵣ⁷=cᵣ⁸} that are common (the same) for layer quadruples (1,2,3,4) and (5,6,7,8), respectively.
In one example, the indicator (i_{1,1}, i_{1,2}) indicates v=5-8 sets of {bᵣ^{l}}, one for each layer, and i₂ indicates up to four sets of {cᵣ¹=cᵣ²}, {cᵣ³=cᵣ⁴}, {cᵣ⁵=cᵣ⁶}, and {cᵣ⁷=cᵣ⁸} that are common (the same) for layer pairs (1,2), (3,4), (5,6), and (7,8), respectively.
In one example, the indicator (i_{1,1}, i_{1,2}) indicates v=5-8 sets of {bᵣ^{l}}, one for each layer, and i₂ indicates v=5-8 sets of {cᵣ^{l}}, one for each layer.

### Type I Port Selection

In one embodiment, a variation of previous embodiments, wherein the SD basis selection matrix is replaced with a SD port selection matrix.

In one example, vₘ_{₁}_{^{(r,jr)}}_{,m}_{₂}_{^{(r,jr)}} is replaced with vᵢ_{_{1,1,r}}_{d+i} (cf. Rel.16 Type II codebook). For CSI-RS resource r, the antenna ports per polarization are selected by the index i_{1,1}=[i_{1,1,1} . . . i_{1,1,N}], where

$${i}_{1 , 1 , r} ∈ \{ 0 , 1 , … , ⌈ \frac{{P}_{CSI - RS , r}}{2 d} ⌉ \} .$$

In one example, vₘ_{₁}_{^{(r,jr)}}_{,m}_{₂}_{^{(r,jr)}} is replaced with vₘ_{_{(r,jr)}} (cf. Rel. 17 Type II codebook).

For CSI-RS resource r, K_{1,r}=2Lᵣ ports are selected from P_{CSIRS,r} ports based on Lᵣ vectors, vₘ_{^{(r,jr)}}, jᵣ=0, 1, . . . , Lᵣ−1, which are identified by

$$m = [ {m}^{( 1 )} … {m}^{( N )} ]$$

$${m}^{( r )} = [ {m}^{( r , 0 )} … {m}^{( r , {L}_{r} - 1 )} ]$$

$${m}^{( r , {j}_{r} )} ∈ \{ 0 , 1 , … , \frac{{P}_{CSIRS , r}}{2} - 1 \}$$

which are indicated by the index i_{1,2}=[i_{1,2,1} . . . i_{1,2,N}], where

$${i}_{1 , 2 , r} ∈ \{ 0 , 1 , … , ( \begin{matrix}\frac{{P}_{CSIRS , r}}{2} \\ {L}_{r}\end{matrix} ) - 1 \} .$$

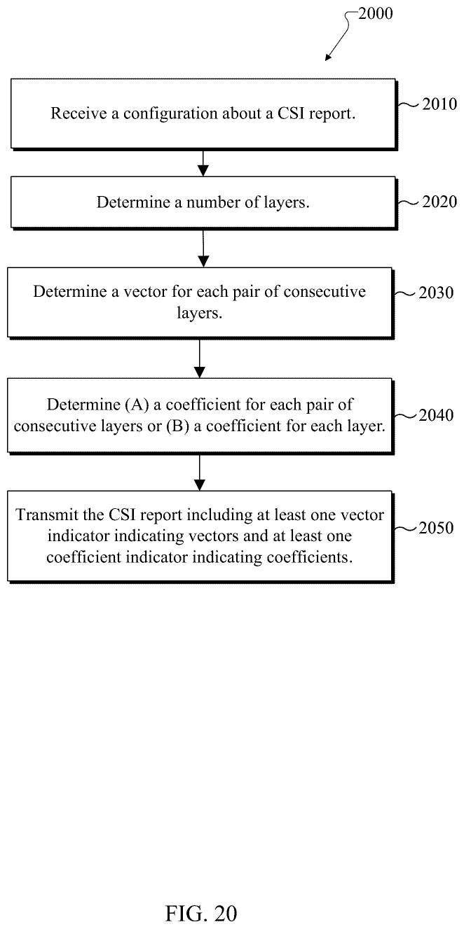

FIG. 20 illustrates an example method 2000 performed by a UE in a wireless communication system according to embodiments of the present disclosure. The method 2000 of FIG. 20 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2000 is for illustration only and other embodiments can be used without departing from the scope of the present disclosure.

The method 2000 begins with the UE receiving a configuration about a CSI report (2010). For example, in 2010, the configuration includes information about K>1 NZP CSI-RS resources and a codebookType and the codebookType indicates a codebook associated with P_{CSIRS} CSI-RS ports aggregated across the K NZP CSI-RS resources.

The UE then determines a number of layers (v) (2020). For example, in 2020, the number of layers may be determined based on the configuration. The UE then determines a vector bᵣ for each pair of consecutive layers (2r−1,2r) (2030). For example, in 2030, the determination is made when v>1. The UE then determines (A) a coefficient cᵣ for each pair of consecutive layers (2r−1,2r) or (B) a coefficient cᵣ for each layer l=1, . . . , v (2040). For example, in 2040, the configuration includes information indicating the one of (A) and (B) and the UE determines the one of (A) and (B) based on the information.

The UE then transmits the CSI report including at least one vector indicator indicating vectors {bᵣ} and at least one coefficient indicator indicating coefficients (2050). For example, in 2050, P_{CSIRS}>32, r=1, . . . , ┌v/2┐, and each vector has a length dependent on P_{CSIRS}.

In various embodiments, K∈{2,3,4}, P_{CSIRS}∈S, a set of values including {64,96,128}, the vectors {bᵣ} are orthogonal DFT vectors, P_{CSIRS}=ΣᵣP_{CSIRS,r}, P_{CSIRS,r}=2N_{1,r}N_{2,r}, and (N_{1,r}, N_{2,r}) is a number of ports in a first and second dimensions of a two-dimensional port layout, and each coefficient c includes at least a phase value from {1, j, −1, −j}. In various embodiments, the K NZP CSI-RS resources have an equal number of CSI-RS ports, (N_{1,r}, N_{2,r})=(N₁,N₂), and at least one first vector indicator includes a 4-bit indicator indicating a value of (q₁, q₂) associated with N₁N₂ orthogonal DFT vectors, where qᵢ∈{0,1,2,3}, and for each layer, a

$$⌈ {log}_{2} ( \begin{matrix}{N}_{1} {N}_{2} \\ 1\end{matrix} ) ⌉ - bit$$

indicator indicating one vector associated with a layer.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to:
receive a configuration about a channel state information (CSI) report, the configuration including information about (i) K>1 non-zero power (NZP) CSI-reference signal (RS) resources and (ii) a codebookType, wherein the codebook Type indicates a codebook associated with P_{CSIRS} CSI-RS ports aggregated across the K NZP CSI-RS resources; and
a processor operably coupled to the transceiver, the processor, based on the configuration, configured to:
determine, a number of layers (v); and
when v>1:
determine a vector bᵣ for each pair of consecutive layers (2r−1,2r), and determine one of:
(A) a coefficient cᵣ for each pair of consecutive layers (2r−1,2r), and
(B) a coefficient c for each layer l,
wherein the transceiver is configured to transmit the CSI report including at least one vector indicator indicating vectors {bᵣ} and at least one coefficient indicator indicating coefficients,
where r is an index of a pair of consecutive layers, l is an index of a layer, P_{CSIRS}>32, r=1, . . . , [v/2], l=1, . . . , v, and each vector has a length dependent on P_{CSIRS}.

2. The UE of claim 1, wherein:
the configuration includes information indicating the one of (A) and (B), and
the processor is further configured to determine the one of (A) and (B) based on the information.

3. The UE of claim 1, wherein:
K∈{2,3,4},
P_{CSIRS}∈S, a set of values including {64,96,128},
the vectors {bᵣ} are orthogonal discrete Fourier transform (DFT) vectors,
P_{CSIRS}=ΣᵣP_{CSIRS,r}, P_{CSIRS,r}=2N_{1,r}N_{2,r}, and (N_{1,r}, N_{2,r}) is a number of ports in a first and second dimensions of a two-dimensional port layout, and
each coefficient includes at least a phase value from {1, j, −1, −j}.

4. The UE of claim 3, wherein:
the K NZP CSI-RS resources have an equal number of CSI-RS ports,
(N_{1,r}, N_{2,r})=(N₁,N₂), and
at least one first vector indicator includes:
a 4-bit indicator indicating a value of (q₁, q₂) associated with N₁N₂ orthogonal DFT vectors, where qᵢ∈{0,1,2,3}, and
for each layer, a
$$⌈ {log}_{2} ( \begin{matrix}{N}_{1} {N}_{2} \\ 1\end{matrix} ) - bit ⌉$$
indicator indicating one vector associated with a layer.

5. The UE of claim 1, wherein, when v=2:
r=1,
l=1,2,
the vectors {bᵣ}={b₁},
the coefficients are one of (A) {cᵣ}={c₁} and (B) {cₗ}={c₁, c₂}, and
a precoding matrix for 2 layers is based on one of
$$\frac{1}{\sqrt{2 {P}_{CSIRS}}} [ \begin{matrix}{b}_{1} & {b}_{1} \\ {c}_{1} {b}_{1} & - {c}_{1} {b}_{1}\end{matrix} ] \qquad ( A )$$
$$and$$
$$\frac{1}{\sqrt{2 {P}_{CSIRS}}} [ \begin{matrix}{b}_{1} & {b}_{1} \\ {c}_{1} {b}_{1} & {c}_{2} {b}_{1}\end{matrix} ] . \qquad ( B )$$

6. The UE of claim 1, wherein:
when v=3 or 4, r=1,2 and the vectors {bᵣ}={b₁, b₂},
when v=3:
l=1,2,3,
the coefficients are one of (A) {cᵣ}={c₁, c₂} and (B) {c₁}={c₁, c₂, c₃}, and
a precoding matrix for 3 layers is based on one of
$$\frac{1}{\sqrt{3 {P}_{CSIRS}}} [ \begin{matrix}{b}_{1} & {b}_{1} & {b}_{2} \\ {c}_{1} {b}_{1} & - {c}_{1} {b}_{1} & {c}_{2} {b}_{2}\end{matrix} ] \qquad ( A )$$
$$and$$
$$\frac{1}{\sqrt{3 {P}_{CSIRS}}} [ \begin{matrix}{b}_{1} & {b}_{1} & {b}_{2} \\ {c}_{1} {b}_{1} & {c}_{2} {b}_{1} & {c}_{3} {b}_{2}\end{matrix} ] , \qquad ( B )$$
and
when v=4:
l=1,2,3,4,
the coefficients are one of (A) {cᵣ}={c₁, c₂} and (B) {c₁}={c₁, c₂, c₃, c₄}, and
a precoding matrix for 4 layers is based one of
$$\frac{1}{2 \sqrt{{P}_{CSIRS}}} [ \begin{matrix}{b}_{1} & {b}_{1} & {b}_{2} & {b}_{2} \\ {c}_{1} {b}_{1} & - {c}_{1} {b}_{1} & {c}_{2} {b}_{2} & - {c}_{2} {b}_{2}\end{matrix} ] \qquad ( A )$$
$$and$$
$$\frac{1}{2 \sqrt{{P}_{CSIRS}}} [ \begin{matrix}{b}_{1} & {b}_{1} & {b}_{2} & {b}_{2} \\ {c}_{1} {b}_{1} & {c}_{2} {b}_{1} & {c}_{3} {b}_{2} & {c}_{4} {b}_{2}\end{matrix} ] . \qquad ( B )$$

7. The UE of claim 1, wherein:
when v=5 or 6, r=1,2,3 and the vectors {bᵣ}={b₁, b₂, b₃},
when v=5:
l=1,2,3,4,5,
the coefficients are one of (A) {cᵣ}={c₁, c₂, c₃} and (B) {c₁}={c₁, c₂, . . . , c₅}, and
a precoding matrix for 5 layers is based on one of
$$\frac{1}{\sqrt{5 {P}_{CSIRS}}} [ \begin{matrix}{b}_{1} & {b}_{1} & {b}_{2} & {b}_{2} & {b}_{3} \\ {c}_{1} {b}_{1} & - {c}_{1} {b}_{1} & {c}_{2} {b}_{2} & - {c}_{2} {b}_{2} & {c}_{3} {b}_{3}\end{matrix} ] and \qquad ( A )$$
$$\frac{1}{\sqrt{5 {P}_{CSIRS}}} [ \begin{matrix}{b}_{1} & {b}_{1} & {b}_{2} & {b}_{2} & {b}_{3} \\ {c}_{1} {b}_{1} & {c}_{2} {b}_{1} & {c}_{3} {b}_{2} & {c}_{4} {b}_{2} & {c}_{5} {b}_{3}\end{matrix} ] , \qquad ( B )$$
and
when v=6:
l=1, 2, . . . 6,
the coefficients are one of (A) {cᵣ}={c₁, c₂, c₃} and (B) {cₗ}={c₁, c₂, . . . , c₆}, and
a precoding matrix for 6 layers is based on one of
$$\frac{1}{\sqrt{6 {P}_{CSIRS}}} [ \begin{matrix}{b}_{1} & {b}_{1} & {b}_{2} & {b}_{2} & {b}_{3} & {b}_{3} \\ {c}_{1} {b}_{1} & - {c}_{1} {b}_{1} & {c}_{2} {b}_{2} & - {c}_{2} {b}_{2} & {c}_{3} {b}_{3} & - {c}_{3} {b}_{3}\end{matrix} ] and \qquad ( A )$$
$$\frac{1}{\sqrt{6 {P}_{CSIRS}}} [ \begin{matrix}{b}_{1} & {b}_{1} & {b}_{2} & {b}_{2} & {b}_{3} & {b}_{3} \\ {c}_{1} {b}_{1} & {c}_{2} {b}_{1} & {c}_{3} {b}_{2} & {c}_{4} {b}_{2} & {c}_{5} {b}_{3} & {c}_{6} {b}_{3}\end{matrix} ] . \qquad ( B )$$

8. The UE of claim 1, wherein when v=7 or 8:
r=1,2,3,4, and the vectors {bᵣ}={b₁, b₂, b₃, b₄},
when v=7:
l=1, 2, . . . 7,
the coefficients are one of (A) {cᵣ}={c₁, c₂, c₃, c₄} and (B) {cₗ}={c₁, c₂, . . . , c₇}, and
a precoding matrix for 7 layers is based on one of
$$\frac{1}{\sqrt{7 {P}_{CSIRS}}} [ \begin{matrix}{b}_{1} & {b}_{1} & {b}_{2} & {b}_{2} & {b}_{3} & {b}_{3} & {b}_{4} \\ {c}_{1} {b}_{1} & - {c}_{1} {b}_{1} & {c}_{2} {b}_{2} & - {c}_{2} {b}_{2} & {c}_{3} {b}_{3} & - {c}_{3} {b}_{3} & {c}_{4} {b}_{4}\end{matrix} ] and \qquad ( A )$$
$$\frac{1}{\sqrt{7 {P}_{CSIRS}}} [ \begin{matrix}{b}_{1} & {b}_{1} & {b}_{2} & {b}_{2} & {b}_{3} & {b}_{3} & {b}_{4} \\ {c}_{1} {b}_{1} & {c}_{2} {b}_{1} & {c}_{3} {b}_{2} & {c}_{4} {b}_{2} & {c}_{5} {b}_{3} & {c}_{6} {b}_{3} & {c}_{7} {b}_{4}\end{matrix} ] , \qquad ( B )$$
and
when v=8:
l=1, 2, . . . 8,
the coefficients are one of (A) {cᵣ}={c₁, c₂, c₃, c₄} and (B) {cₗ}={c₁, c₂, . . . , c₈}, and
a precoding matrix for 8 layers is based on one of
$$\frac{1}{2 \sqrt{2 {P}_{CSIRS}}} [ \begin{matrix}{b}_{1} & {b}_{1} & {b}_{2} & {b}_{2} & {b}_{3} & {b}_{3} & {b}_{4} & {b}_{4} \\ {c}_{1} {b}_{1} & - {c}_{1} {b}_{1} & {c}_{2} {b}_{2} & - {c}_{2} {b}_{2} & {c}_{3} {b}_{3} & - {c}_{3} {b}_{3} & {c}_{4} {b}_{4} & - {c}_{4} {b}_{4}\end{matrix} ] \\ and \qquad ( A )$$
$$\frac{1}{2 \sqrt{2 {P}_{CSIRS}}} [ \begin{matrix}{b}_{1} & {b}_{1} & {b}_{2} & {b}_{2} & {b}_{3} & {b}_{3} & {b}_{4} & {b}_{4} \\ {c}_{1} {b}_{1} & {c}_{2} {b}_{1} & {c}_{3} {b}_{2} & {c}_{4} {b}_{2} & {c}_{5} {b}_{3} & {c}_{6} {b}_{3} & {c}_{7} {b}_{4} & {c}_{8} {b}_{4}\end{matrix} ] . \qquad ( B )$$

9. A base station (BS) comprising:
a processor; and
a transceiver operably coupled to the processor, the transceiver configured to:
transmit a configuration about a channel state information (CSI) report, the configuration including information about (i) K>1 non-zero power (NZP) CSI-reference signal (RS) resources and (ii) a codebookType, wherein the codebookType indicates a codebook associated with P_{CSIRS} CSI-RS ports aggregated across the K NZP CSI-RS resources; and
receive the CSI report including at least one vector indicator indicating vectors {bᵣ} and at least one coefficient indicator indicating coefficients,
wherein, when a number of layers (v)>1:
a vector bᵣ is determined for each pair of consecutive layers (2r−1,2r), and one of:
(A) a coefficient cᵣ is determined for each pair of consecutive layers (2r−1,2r), and
(B) a coefficient cₗ is determined for each layer l,
where r is an index of a pair of consecutive layers, l is an index of a layer, P_{CSIRS}>32, r=1, . . . , ┌v/2┐, l=1, . . . , v, and each vector has a length dependent on P_{CSIRS}.

10. The BS of claim 9, wherein the configuration includes information indicating the one of (A) and (B).

11. The BS of claim 9, wherein:
K∈{2,3,4},
P_{CSIRS}∈S, a set of values including {64,96,128},
the vectors {bᵣ} are orthogonal discrete Fourier transform (DFT) vectors,
P_{CSIRS}=ΣᵣP_{CSIRS,r}, P_{CSIRS,r}=2N_{1,r}N_{2,r}, and (N_{1,r}, N_{2,r}) is a number of ports in a first and second dimensions of a two-dimensional port layout, and
each coefficient cₗ includes at least a phase value from {1, j, −1, −j}.

12. The BS of claim 11, wherein:
the K NZP CSI-RS resources have an equal number of CSI-RS ports,
(N_{1,r}, N_{2,r})=(N₁,N₂), and
at least one first vector indicator includes:
a 4-bit indicator indicating a value of (q₁, q₂) associated with N₁N₂ orthogonal DFT vectors, where qᵢ∈{0,1,2,3}, and
for each layer, a
$$⌈ {log}_{2} ( \begin{matrix}{N}_{1} {N}_{2} \\ 1\end{matrix} ) - bit ⌉$$
indicator indicating one vector associated with a layer.

13. The BS of claim 9, wherein, when v=2:
r=1,
l=1,2,
the vectors {bᵣ}={bₗ},
the coefficients are one of (A) {cᵣ}={c₁} and (B) {cₗ}={c₁, c₂}, and
a precoding matrix for 2 layers is based on one of
$$\frac{1}{\sqrt{2 {P}_{CSIRS}}} [ \begin{matrix}{b}_{1} & {b}_{1} \\ {c}_{1} {b}_{1} & - {c}_{1} {b}_{1}\end{matrix} ] and \qquad ( A )$$
$$\frac{1}{\sqrt{2 {P}_{CSIRS}}} [ \begin{matrix}{b}_{1} & {b}_{1} \\ {c}_{1} {b}_{1} & {c}_{2} {b}_{1}\end{matrix} ] . \qquad ( B )$$

14. The BS of claim 9, wherein:
when v=3 or 4, r=1,2 and the vectors {bᵣ}={b₁, b₂},
when v=3:
l=1,2,3,
the coefficients are one of (A) {cᵣ}={c₁, c₂} and (B) {cₗ}={c₁, c₂, c₃}, and
a precoding matrix for 3 layers is based on one of
$$\frac{1}{\sqrt{3 {P}_{CSIRS}}} [ \begin{matrix}{b}_{1} & {b}_{1} & {b}_{2} \\ {c}_{1} {b}_{1} & - {c}_{1} {b}_{1} & {c}_{2} {b}_{2}\end{matrix} ] and \qquad ( A )$$
$$\frac{1}{\sqrt{3 {P}_{CSIRS}}} [ \begin{matrix}{b}_{1} & {b}_{1} & {b}_{2} \\ {c}_{1} {b}_{1} & {c}_{2} {b}_{1} & {c}_{3} {b}_{2}\end{matrix} ] , \qquad ( B )$$
and
when v=4:
l=1,2,3,4,
the coefficients are one of (A) {cᵣ}={c₁, c₂} and (B) {cₗ}={c₁, c₂, c₃, c₄}, and
a precoding matrix for 4 layers is based on one of
$$\frac{1}{2 \sqrt{{P}_{CSIRS}}} [ \begin{matrix}{b}_{1} & {b}_{1} & {b}_{2} & {b}_{2} \\ {c}_{1} {b}_{1} & - {c}_{1} {b}_{1} & {c}_{2} {b}_{2} & - {c}_{2} {b}_{2}\end{matrix} ] and \qquad ( A )$$
$$\frac{1}{2 \sqrt{{P}_{CSIRS}}} [ \begin{matrix}{b}_{1} & {b}_{1} & {b}_{2} & {b}_{2} \\ {c}_{1} {b}_{1} & {c}_{2} {b}_{1} & {c}_{3} {b}_{2} & {c}_{4} {b}_{2}\end{matrix} ] . \qquad ( B )$$

15. The BS of claim 9, wherein:
when v=5 or 6, r=1,2,3 and the vectors {bᵣ}={b₁, b₂, b₃},
when v=5:
l=1,2,3,4,5,
the coefficients are one of (A) {cᵣ}={c₁, c₂, c₃} and (B) {cₗ}={c₁, c₂, . . . , c₅}, and
a precoding matrix for 5 layers is based on one of
$$\frac{1}{\sqrt{5 {P}_{CSIRS}}} [ \begin{matrix}{b}_{1} & {b}_{1} & {b}_{2} & {b}_{2} & {b}_{3} \\ {c}_{1} {b}_{1} & - {c}_{1} {b}_{1} & {c}_{2} {b}_{2} & - {c}_{2} {b}_{2} & {c}_{3} {b}_{3}\end{matrix} ] and \qquad ( A )$$
$$\frac{1}{\sqrt{5 {P}_{CSIRS}}} [ \begin{matrix}{b}_{1} & {b}_{1} & {b}_{2} & {b}_{2} & {b}_{3} \\ {c}_{1} {b}_{1} & {c}_{2} {b}_{1} & {c}_{3} {b}_{2} & {c}_{4} {b}_{2} & {c}_{5} {b}_{3}\end{matrix} ] , \qquad ( B )$$
and
when v=6:
l=1, 2, . . . 6,
the coefficients are one of (A) {cᵣ}={c₁, c₂, c₃} and (B) {cₗ}={c₁, c₂, . . . , c₆}, and
a precoding matrix for 6 layers is based on one of
$$\frac{1}{\sqrt{6 {P}_{CSIRS}}} [ \begin{matrix}{b}_{1} & {b}_{1} & {b}_{2} & {b}_{2} & {b}_{3} & {b}_{3} \\ {c}_{1} {b}_{1} & - {c}_{1} {b}_{1} & {c}_{2} {b}_{2} & - {c}_{2} {b}_{2} & {c}_{3} {b}_{3} & - {c}_{3} {b}_{3}\end{matrix} ] and \qquad ( A )$$
$$\frac{1}{\sqrt{6 {P}_{CSIRS}}} [ \begin{matrix}{b}_{1} & {b}_{1} & {b}_{2} & {b}_{2} & {b}_{3} & {b}_{3} \\ {c}_{1} {b}_{1} & {c}_{2} {b}_{1} & {c}_{3} {b}_{2} & {c}_{4} {b}_{2} & {c}_{5} {b}_{3} & {c}_{6} {b}_{3}\end{matrix} ] . \qquad ( B )$$

16. The BS of claim 9, wherein:
when v=7 or 8, r=1,2,3,4 and the vectors {bᵣ}={b₁, b₂, b₃, b₄},
when v=7:
l=1, 2, . . . 7,
the coefficients are one of (A) {cᵣ}={c₁, c₂, c₃, c₄} and (B) {cₗ}={c₁, c₂, . . . , c₇}, and
a precoding matrix for 7 layers is based on one of
$$\frac{1}{\sqrt{7 {P}_{CSIRS}}} [ \begin{matrix}{b}_{1} & {b}_{1} & {b}_{2} & {b}_{2} & {b}_{3} & {b}_{3} & {b}_{4} \\ {c}_{1} {b}_{1} & - {c}_{1} {b}_{1} & {c}_{2} {b}_{2} & - {c}_{2} {b}_{2} & {c}_{3} {b}_{3} & - {c}_{3} {b}_{3} & {c}_{4} {b}_{4}\end{matrix} ] and \qquad ( A )$$
$$\frac{1}{\sqrt{7 {P}_{CSIRS}}} [ \begin{matrix}{b}_{1} & {b}_{1} & {b}_{2} & {b}_{2} & {b}_{3} & {b}_{3} & {b}_{4} \\ {c}_{1} {b}_{1} & {c}_{2} {b}_{1} & {c}_{3} {b}_{2} & {c}_{4} {b}_{2} & {c}_{5} {b}_{3} & {c}_{6} {b}_{3} & {c}_{7} {b}_{4}\end{matrix} ] , \qquad ( B )$$
and
when v=8:
l=1, 2, . . . 8,
the coefficients are one of (A) {cᵣ}={c₁, c₂, c₃, c₄} and (B) {cₗ}={c₁, c₂, . . . , c₈}, and
a precoding matrix for 8 layers is based on one of
$$\frac{1}{2 \sqrt{2 {P}_{CSIRS}}} [ \begin{matrix}{b}_{1} & {b}_{1} & {b}_{2} & {b}_{2} & {b}_{3} & {b}_{3} & {b}_{4} & {b}_{4} \\ {c}_{1} {b}_{1} & - {c}_{1} {b}_{1} & {c}_{2} {b}_{2} & - {c}_{2} {b}_{2} & {c}_{3} {b}_{3} & - {c}_{3} {b}_{3} & {c}_{4} {b}_{4} & - {c}_{4} {b}_{4}\end{matrix} ] \\ and \qquad ( A )$$
$$\frac{1}{2 \sqrt{2 {P}_{CSIRS}}} [ \begin{matrix}{b}_{1} & {b}_{1} & {b}_{2} & {b}_{2} & {b}_{3} & {b}_{3} & {b}_{4} & {b}_{4} \\ {c}_{1} {b}_{1} & {c}_{2} {b}_{1} & {c}_{3} {b}_{2} & {c}_{4} {b}_{2} & {c}_{5} {b}_{3} & {c}_{6} {b}_{3} & {c}_{7} {b}_{4} & {c}_{8} {b}_{4}\end{matrix} ] . \qquad ( B )$$

17. A method performed by a user equipment (UE), the method comprising:
receiving a configuration about a channel state information (CSI) report, the configuration including information about (i) K>1 non-zero power (NZP) CSI-reference signal (RS) resources and (ii) a codebookType, wherein the codebookType indicates a codebook associated with P_{CSIRS} CSI-RS ports aggregated across the K NZP CSI-RS resources;
based on the configuration, determining a number of layers (v); and
when v>1:
determining a vector bᵣ for each pair of consecutive layers (2r−1,2r), and
determining one of:
(A) a coefficient cᵣ for each pair of consecutive layers (2r−1,2r), and
(B) a coefficient cₗ for each layer l; and
transmitting the CSI report including at least one vector indicator indicating vectors {bᵣ} and at least one coefficient indicator indicating coefficients,
where r is an index of a pair of consecutive layers, l is an index of a layer, P_{CSIRS}>32, r=1, . . . , [v/2], l=1, . . . , v, and each vector has a length dependent on P_{CSIRS}.

18. The method of claim 17, wherein:
the configuration includes information indicating the one of (A) and (B), and
the determination of the one of (A) and (B) is based on the information.

19. The method of claim 17, wherein:
K∈{2,3,4},
P_{CSIRS}∈S, a set of values including {64,96,128},
the vectors {bᵣ} are orthogonal discrete Fourier transform (DFT) vectors,
P_{CSIRS}=ΣᵣP_{CSIRS,r}, P_{CSIRS,r}=2N_{1,r}N_{2,r}, and (N_{1,r}, N_{2,r}) is a number of ports in a first and second dimensions of a two-dimensional port layout, and
each coefficient cₗ includes at least a phase value from {1, j, −1, −j}.

20. The method of claim 19, wherein:
the K NZP CSI-RS resources have an equal number of CSI-RS ports,
(N_{1,r}, N_{2,r})=(N₁,N₂), and
at least one first vector indicator includes:
a 4-bit indicator indicating a value of (q₁, q₂) associated with N₁N₂ orthogonal DFT vectors, where qᵢ∈{0,1,2,3}, and
for each layer, a
$$⌈ {log}_{2} ( \begin{matrix}{N}_{1} {N}_{2} \\ 1\end{matrix} ) - bit ⌉$$
indicator indicating one vector associated with a layer.
